(19) United States
(12) Patent Application Publication
(10) Pub. No.: US 2013/0191770 A1
(43) Pub. Date: Jul. 25, 2013

(54) METHOD OF INPUTTING DATA INTO AN INFUSION PUMP

(71) Applicants: Troy A. Bartz, Lake Orion, MI (US); Paul T. Kotnik, Commerce Township, MI (US); Monika Zeinert, Waterford, MI (US); Robert R. Voltenburg, Davison, MI (US); Rana Balci, Troy, MI (US)

(72) Inventors: Troy A. Bartz, Lake Orion, MI (US); Paul T. Kotnik, Commerce Township, MI (US); Monika Zeinert, Waterford, MI (US); Robert R. Voltenburg, Davison, MI (US); Rana Balci, Troy, MI (US)

(73) Assignee: CURLIN MEDICAL INC., East Aurora, NY (US)

(21) Appl. No.: 13/127,522

(22) PCT Filed: Nov. 9, 2009
(86) PCT No.: PCT/US09/63730

§ 371 Date: Sep. 16, 2011

Related U.S. Application Data
(60) Provisional application No. 61/198,817, filed on Nov. 10, 2008.

(51) Int. Cl. G06F 3/0484

(52) U.S. Cl. CPC G06F 3/0484
USPC 715/771

(57) ABSTRACT

A method of inputting data into an infusion pump includes inputting the data into a user interface using a data entry system. The user interface includes i) the data entry system for inputting the data related to a drug, a subject, a caregiver, and a protocol for infusing the drug to the subject, ii) a display operative associated with the data entry system, and iii) a processor operatively associated with the display and the data entry system, where the processor has stored therein a program for prompting a user of the infusion pump, via a screen presented on the display, for respective data entry.

### CROSS REFERENCE TO RELATED APPLICATION

This application claims the benefit of U.S. Provisional Patent Application Ser. No. 61/198,817 for a METHOD OF INPUTTING DATA INTO AN INFUSION PUMP, filed on Nov. 10, 2008, which is hereby incorporated by reference in its entirety. This claim is made under 35 U.S.C. §119(e); 37 C.F.R. §1.78; and 65 Fed. Reg. 50093.

### TECHNICAL FIELD OF INVENTION

The present disclosure relates generally to infusion pumps, and more particularly to a method of inputting data into an infusion pump.

### BACKGROUND

Infusion pumps are often used to deliver fluid in a controlled manner such as, for example, an intravenous delivery of pharmaceutical compositions (i.e., a drug) to a patient or subject. In many cases, the infusion pump is programmable with an infusion protocol for delivering the drug to the patient. The infusion protocol may include, for example, the name of the particular drug and data associated with the particular drug.

### SUMMARY

A method of inputting data into an infusion pump includes inputting the data into a user interface using a data entry system. The user interface includes i) the data entry system for inputting the data related to a drug, a subject, a caregiver, and a protocol for infusing the drug to the subject, ii) a display operative associated with the data entry system, and iii) a processor operatively associated with the display and the data entry system, where the processor has stored therein a program for prompting a user of the infusion pump, via a screen presented on the display, for respective data entry.

### BRIEF DESCRIPTION OF THE DRAWINGS

Features and advantages of embodiment(s) of the present disclosure will become apparent by reference to the following detailed description and drawings, in which like reference numerals correspond to similar, though perhaps not identical components. Reference numerals having a previously described function may or may not be described in connection with other drawings in which they appear.

FIG. 1 is a semi-schematic depiction of an example of an infusion pump system;

FIG. 2 is a flow diagram depicting manual data entry of a patient's name, a caregiver's name, and a drug into an infusion pump;

FIG. 3 is a flow diagram depicting electronic data entry of a patient's name, a caregiver's name, and a drug into an infusion pump;

FIGS. 4A-4C are flow diagrams depicting a non-weight-based continuous delivery method of inputting data into the infusion pump;

FIGS. 5A-5C are flow diagrams depicting a method inputted data into an infusion pump for i) a multi-day infusion and ii) a delay infusion;

FIG. 6 is a flow diagram depicting a method of locking a display screen of the infusion pump;

FIG. 7 is a flow diagram depicting a method of inputting data for operating the pump by titration;

FIG. 8 is a flow diagram depicting a method of inputting data for a rate change during for a non-weight-based continuous mode;

FIGS. 9A-9C are flow diagrams depicting a method of inputting data into an infusion pump for a secondary infusion for a non-weight-based continuous mode;

FIGS. 10A-10C are flow diagrams depicting a method of inputting data into an infusion pump for a weight-based continuous mode;

FIG. 11 is a flow diagram depicting a method of inputting data into an infusion pump for a rate change during a weight-based continuous mode;

FIGS. 12A-12B are flow diagrams depicting a method of inputting data into an infusion pump for a secondary infusion for a weight-based continuous mode;

FIGS. 13A-13D are flow diagrams depicting a method of inputting data into an infusion pump for a dose-based intermittent mode;

FIG. 14 is a flow diagram depicting a method of inputting data into an infusion pump for changing a drug reservoir;

FIGS. 15A-15C are flow diagrams depicting a method of inputting data into an infusion pump for a multi-dose intermittent mode;

FIGS. 16A-16E are flow diagrams depicting a method of inputting data into an infusion pump for a patient-controlled analgesia (PCA) mode;

FIGS. 17A-17D are flow diagrams depicting a method of inputting data into an infusion pump for a total parenteral nutrition (TPN) mode;

FIG. 18 is a flow diagram depicting a method of inputting data into an infusion pump for ramping down a flow rate during a TPN mode;

FIG. 19 is a flow diagram depicting a method of inputting data into an infusion pump for an epidural mode;

FIGS. 20A-20B are flow diagrams depicting a method of inputting data into an infusion pump for a quick start mode;

FIG. 21 is a flow diagram for inputting data into an infusion pump for selecting or changing one or more pump options; and

FIGS. 22-24 are flow diagrams for inputting a duplicate caregiver's name, a duplicate drug, and a duplicate patient's name, respectively, into the infusion pump.

### DETAILED DESCRIPTION

Embodiment(s) of the method as disclosed herein may advantageously be used to input, into an infusion pump, data pertaining to, for example, a drug, a subject, a caregiver, and/or a protocol for infusing the drug. Data may be input into the infusion pump manually or may be electronically inputted into the pump using a user interface having a display associated therewith. The user interface is configured so that i) the data may be input without having to include decimal points, thereby reducing errors in decimal point entry (e.g., entering 1.2 mL/hr as opposed to mistakenly entering 102 mL/hr), ii) the inputted data may be reviewed on a review screen presented on the display before starting an actual infusion, and iii) one piece of data is entered into the pump per entry screen presented on the display. Accordingly, data may be inputted or entered into the pump substantially easily, efficiently, and with less inputting errors.

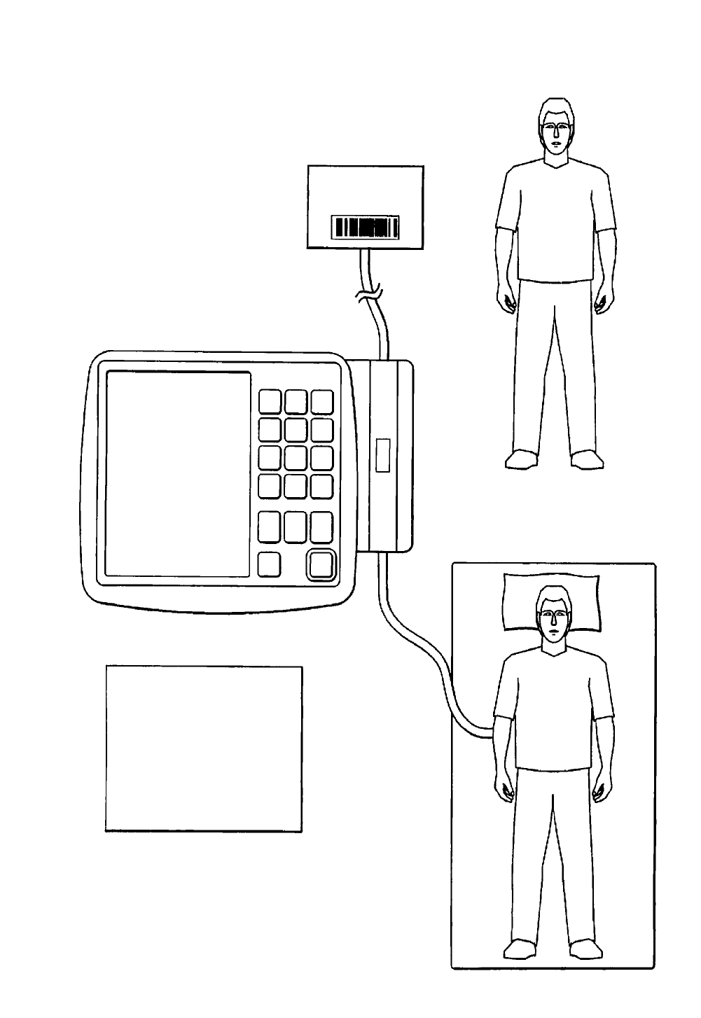

An example of an infusion pump system 10 that may be used for embodiment(s) of the method disclosed herein is semi-schematically depicted in FIG. 1. The infusion pump system 10 includes an infusion pump 12, such as a rotary peristaltic pump as shown in FIG. 1. Such rotary peristaltic infusion pumps may include a removable cassette 30 including an assembly of rollers (not shown) and a flexible tube 32 that surrounds a portion of the assembly of rollers. In response to rotational movement of the rollers, portions of the flexible tube 32 in contact with the rollers compress or otherwise occlude against a wall of the cassette 30. As a result, fluid (i.e., a drug) traveling through the tube 32 is temporarily trapped in the tube 32 between the occluded points. The trapped drug is released from the tube 32 when the occlusion force on the tube 32 is released. In this manner, the drug is urged through the tube 32 via peristaltic wave action and is ultimately delivered to a patient or subject 38.

While a rotary peristaltic pump is shown and described herein, it is to be understood, that other infusion pumps are also suitable for use in the methods of the present disclosure. Examples of such other infusion pumps include syringe pumps and linear peristaltic pumps.

The infusion pump 12 also includes a user interface 16 operatively connected thereto. The user interface 16 includes a data entry system 18 for inputting data related to, for example, a drug, a subject 38, a caregiver 42, and/or a protocol for infusing the drug to the subject 38. In one example, the data entry system 18 is a twelve-digit keypad, operatively associated with a display 20, which together enable manual entry of the data. The display 20 may, in an example, be a standard display exhibiting black-and-white and/or color graphic and alpha-numeric characters. The display 20 may, in another example, be a color touch screen.

In some cases, the display 20 may further include an ambient light detection feature (not shown) to determine how optically bright the ambient environment is. The light detection feature may automatically adjust the backlighting of the display 20 depending, at least in part, on increased or decreased lighting of the ambient environment. Further, the display 20 may include a dimming feature, where the optical brightness of the display 20 dims when the infusion pump 12 is continuously operated at substantially the same setting(s).

In another example, the data entry system 18′ is a machine-readable scanner 24 operatively associated with the infusion pump 12. In some instances, the machine-readable scanner 24 communicates with the infusion pump 12 via a wired connection. In other instances, the machine-readable scanner 24 communicates with the infusion pump 12 via a wireless connection. In these instances, the machine-readable scanner 24 wirelessly transmits the data to the infusion pump 12, and the infusion pump 12 receives the data via a receiver R operatively connected to the user interface 16.

In an example, the machine-readable scanner 24 is a barcode scanner configured to read barcode labels having information stored thereon. In some cases, a barcode label may be associated with a subject or patient 38 and include data such as the subject's name and personal information related to the subject 38 (e.g., allergies, current health status, etc.). Another barcode label may be associated with the caregiver 42 and include data such as the caregiver's name and other relevant identification information related to the caregiver 42. Yet another barcode label (shown as reference numeral 36 in FIG. 1) may be associated with a drug container 34 and include data such as a drug name, data associated with the drug corresponding to the drug name, and a protocol for infusing the drug to the subject 38. The data included in any of the barcode labels described above may be used to program the infusion pump 12 and/or verify that the recipient of the drug to be infused is accurate, which is described in further detail in U.S. Patent Provisional Application Ser. No. 61/198,681 (Docket No. DP-318233), the disclosure of which is herein incorporated by reference in its entirety. U.S. Patent Provisional Application Ser. No. 61/198,853 (Docket No. DP-318242), the disclosure of which is also herein incorporated by reference in its entirety.

The user interface 16 further includes a processor P operatively associated with the display 20 and the data entry system 18. The processor P has stored therein a program for prompting a user of the infusion pump 12, via screens presented on the display 20, for respective data entry. For example, a screen presented on the display 20 may appear prompting a user of the pump 12 (e.g., the caregiver 42) to input or enter one piece of data. After entering that piece of data, another screen may be presented on the display 20 prompting the user to enter another piece of data. This pattern continues until all of the desirable and/or necessary data is entered into the infusion pump 12 for a particular infusion to take place.

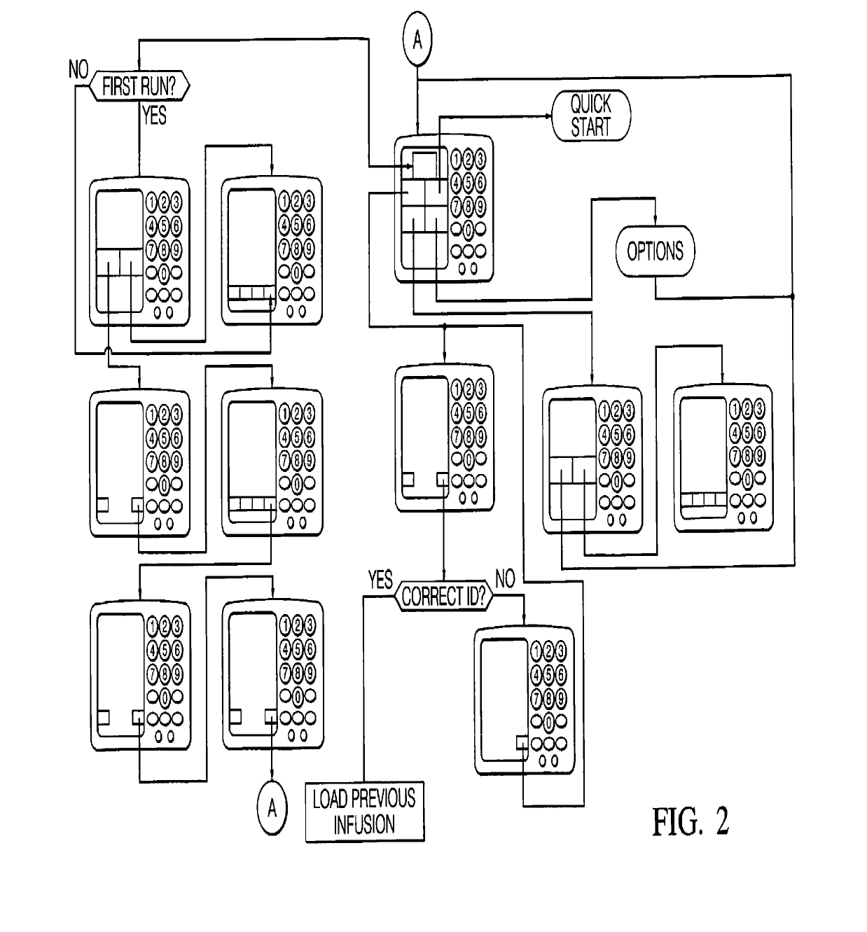

Several embodiments of the method of inputting data into the infusion pump 12 is described hereinbelow with respect to FIGS. 2 through 21. It is to be understood that the reference numerals set forth in FIG. 1 have been omitted from FIGS. 2 through 21 for clarity. In some embodiments, inputting the data is accomplished manually. In other embodiments, inputting the data is accomplished electronically via, e.g., a barcode scan.

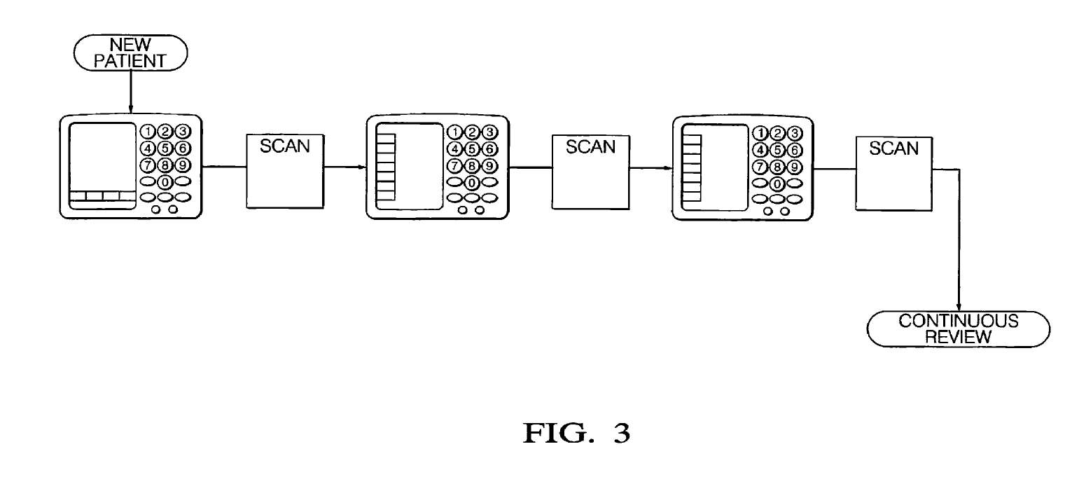

Referring now to FIGS. 2 and 3, an introductory screen is presented on the display that provides several choices for operating the infusion pump. In the embodiment depicted in FIG. 2, the user may select a new patient function, a repeat infusion function, a quick start function, a care area selection function, and a pump options function.

The new patient function allows a user of the infusion pump to enter at least the patient's name, the caregiver's name, and a desired mode of operating the infusion pump. In an example, the user is prompted for data, on respective display screens, related to the patient's (or subject's) name, the caregiver's name, and the drug to be infused to the patient. The patient's name, the caregiver's name, and/or the drug may be entered manually or by scanning a barcode label worn by the patient, worn by the caregiver, or provided on a drug reservoir containing the drug, respectively.

In another example, on another respective display screen, the user is prompted for data related to a care area of where the infusion will take place. The care area may be manually inputted into the pump or may be electronically inputted in the pump from the barcode label associated with the drug reservoir.

The example shown in FIG. 2 depicts how the data may be manually input into the pump. In this example, the data may be input by typing the relevant information using the twelve-digit keypad. For example, at the input screen for inputting the patient's name, the user of the pump will manually enter the patient's name using the keypad and any additional information pertaining to the patient on respective screens presented to the user thereafter.

The example shown in FIG. 3, however, depicts how the data may be inputted into the pump electronically. In this example, the data is input by scanning a barcode label including the data embedded therein. In an embodiment, when prompted by the appropriate screens presented on the display, the barcode label for the patient may be scanned using the machine-readable scanner, the barcode label for the caregiver may be scanned using the machine-readable scanner, and the barcode label for the drug reservoir may be scanned using the machine-readable scanner. When a barcode label is scanned, intermediate screens requesting data in that particular category (e.g., the patient's name) is bypassed and the input screen for the next category (e.g., the caregiver's name) is presented on the display.

In some instances, the barcode label may not include all of the information requested by the pump. For example, the barcode label for the drug reservoir may include the drug name to be infused and some data associated with the drug. However, a protocol for infusing the drug may not be provided in the barcode label. In these instances, some of the intermediate screens may be bypassed, while others may appear which request the information not provided in the barcode label.

It is to be understood that one of the patient's name, the caregiver's name, or the drug name may be manually inputted into the pump, while the others are scanned into the pump, or visa versa. It is further to be understood that if one or more of the patient's name, the caregiver's name, or the drug name are scanned into the pump, the order of scanning is immaterial. In an embodiment, the pump is configured to recognize the difference between the patient's name, the caregiver's name, and the drug name, thus allowing any combination of inputting the data into the pump.

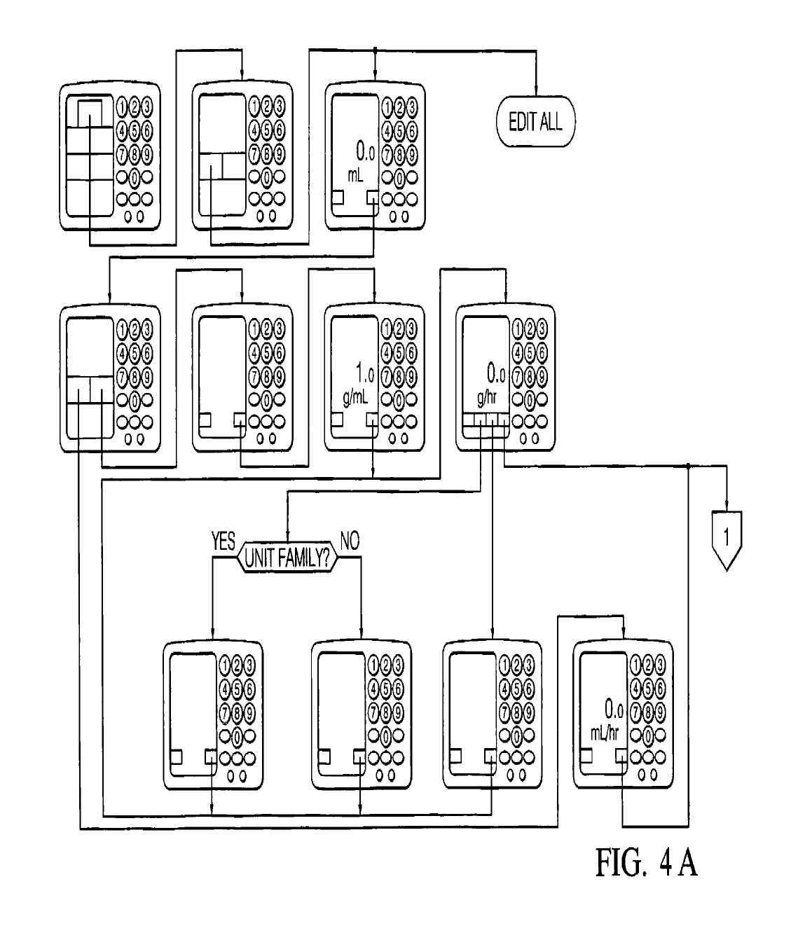

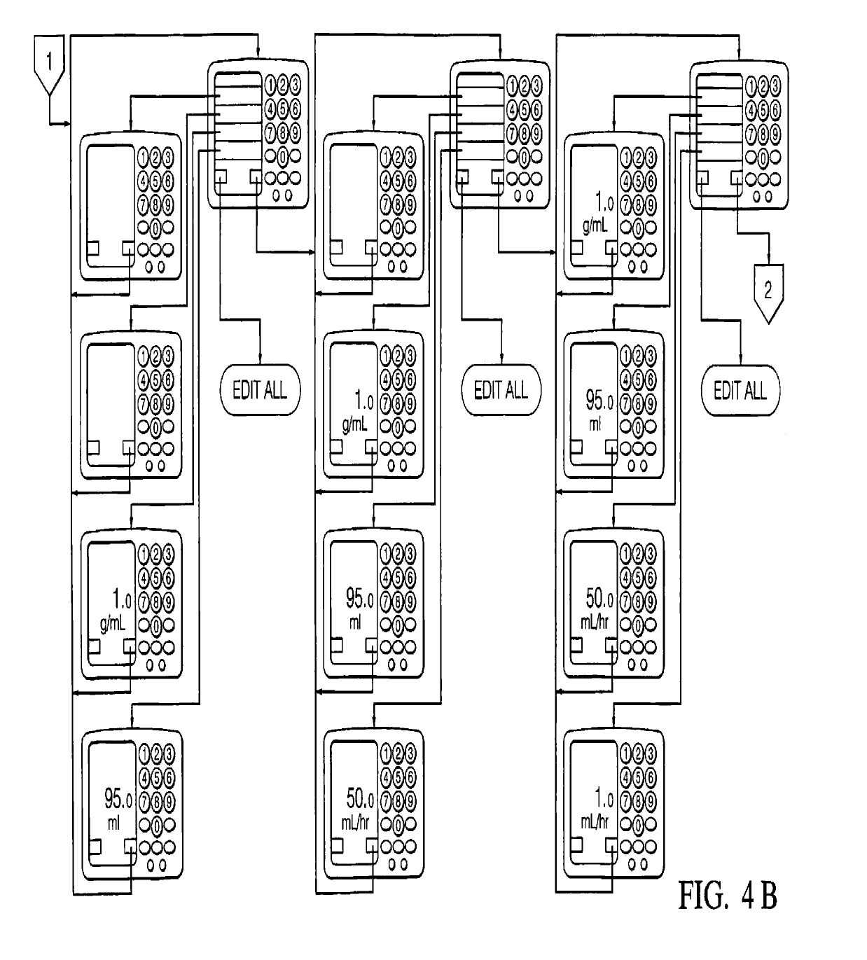

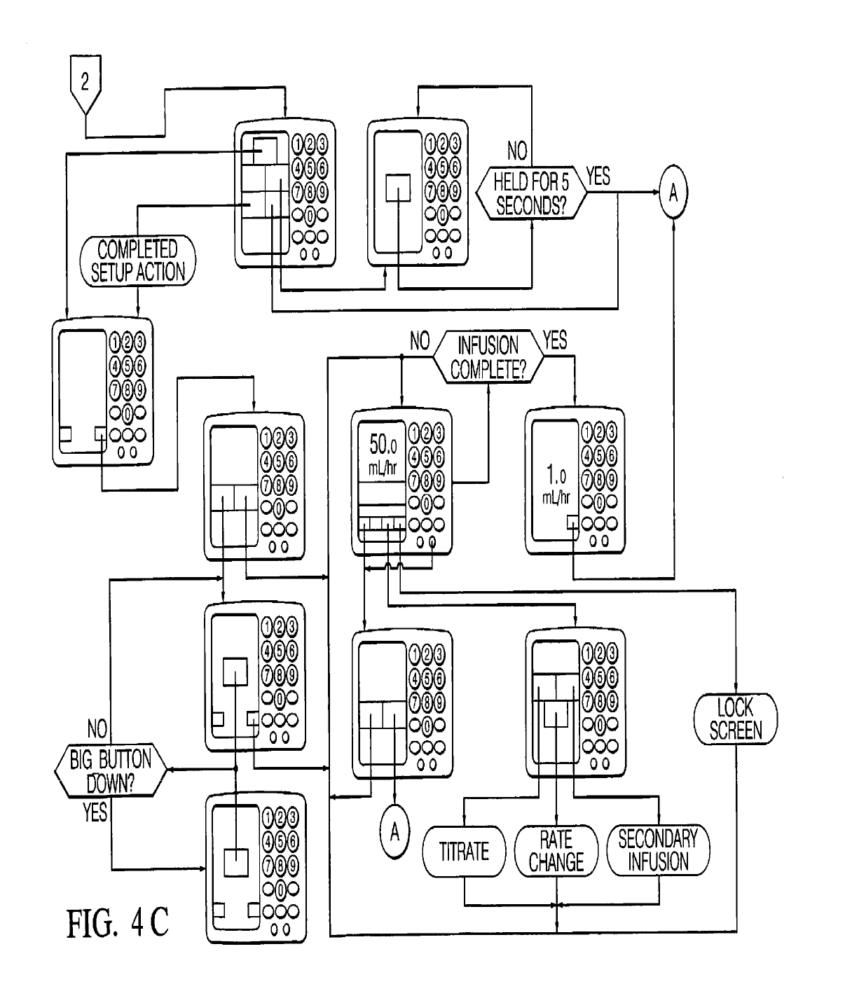

Referring back to FIG. 2, the new patient function also enables the user to select a mode of operating the infusion pump. In many instances, the barcode label associated with the drug reservoir will include the mode of operation as part of the infusion protocol, which is scanned into the infusion pump. However, if the data associated with the drug is manually input into the pump, the mode of operation may be selected by the user. Such modes may be selected from a continuous mode (or delivery), a PCA mode, an intermittent mode, a TPN mode, or an epidural mode. Infusion parameters for the mode of operating the pump selected by the user may be inputted into the pump on respective screens presented to the user via the display. Data entry for these modes of operation will be described in further detail below in conjunction with FIGS. 4 through 21.

Manual data input for a non-weight-based continuous mode or delivery is shown in the flow diagrams depicted in FIGS. 4A-4C. Infusion parameters inputted for the non-weight-based continuous mode include a volume of the drug to be infused, a dosage amount, and an infusion rate. In another embodiment, a concentration of the drug is also input into the pump. It is to be understood that the infusion parameters for any of the data inputted into the pump for any mode of operation include both numerical values and units. It is further to be understood that, in some cases, the numerical value of a particular infusion parameter is input in response to one screen, while the units for the infusion parameter are input (or in some instances selected from a list of possible units) in response to another screen.

After all of the infusion parameters have been input into the pump, the inputted data may be reviewed by the user. In an example, a review screen is presented on the display that allows the user of the pump to selected any of the input information, for example, the subject's name, the drug name, the concentration of the drug, and the volume of the drug to be infused (as shown in FIG. 4B). The user may select and edit any one or more of the data items listed above. Editing different information may be accomplished via separate screens presented on the display.

When the user is finished reviewing and/or editing the patient's name, the drug name, and/or the infusion parameters, the user may select to begin the infusion. If the user selects to begin the infusion, the user is presented with a series of display screens for i) confirming that an occlusion slider for the cassette is in a non-occluded position, ii) determining whether the pump is primed, and iii) priming the pump in the event that the pump is not primed. Once the various elements are in place and/or are primed, the infusion commences.

In some instances, the user may also be presented with other alternatives for starting the infusion. These choices include a save option, a multi-day infusion option, a delay infusion option, or a quit option.

In an example, if the user selects the save option, the data inputted into the infusion pump is saved in a patient's profile on the pump. This profile may be retrieved by the user of the pump at another time to begin the infusion. If, however, the user selects the quit option, then the pump automatically powers off without saving the data inputted into the pump.

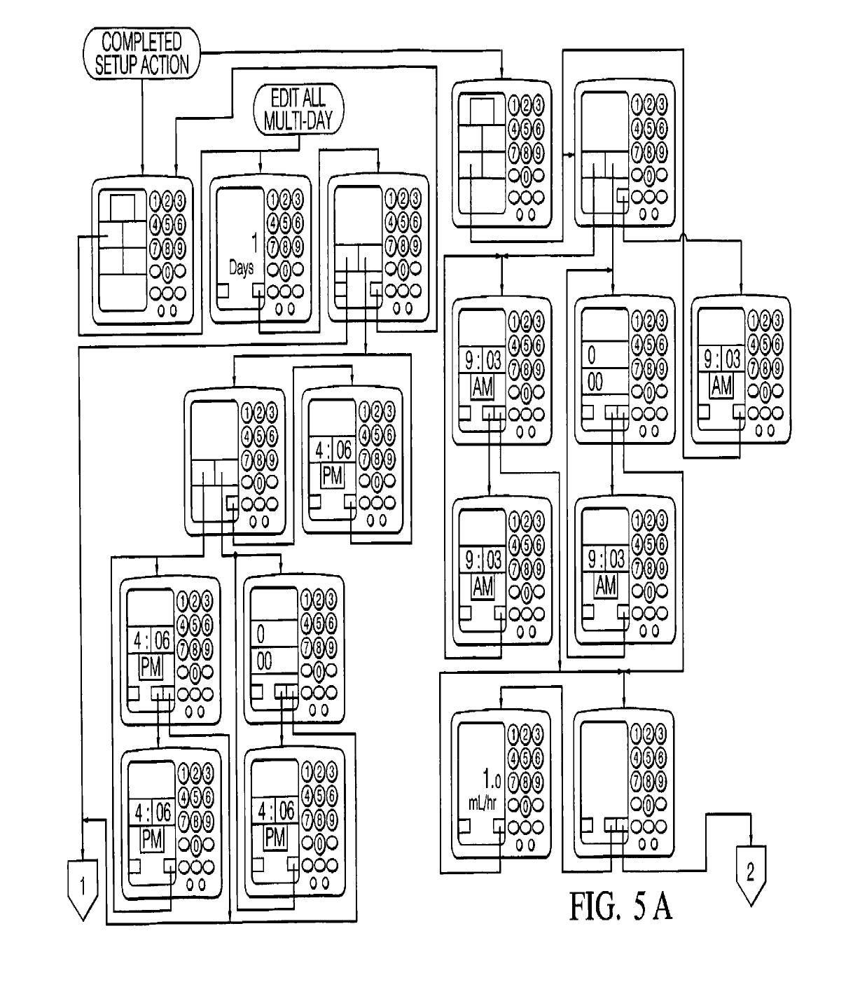

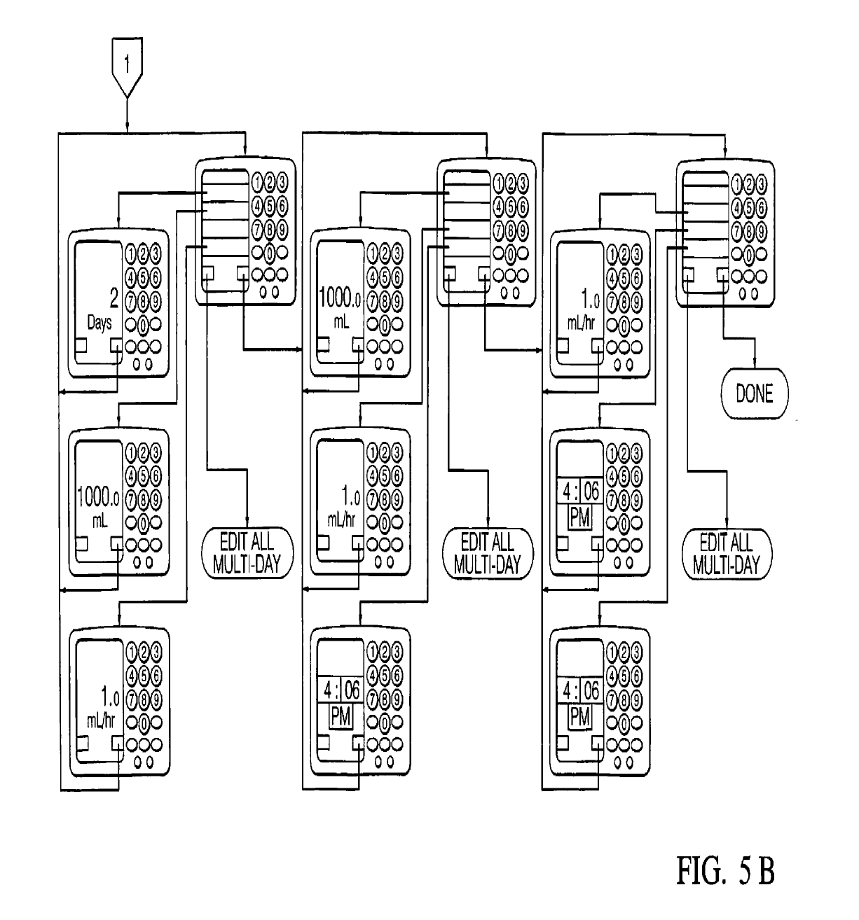

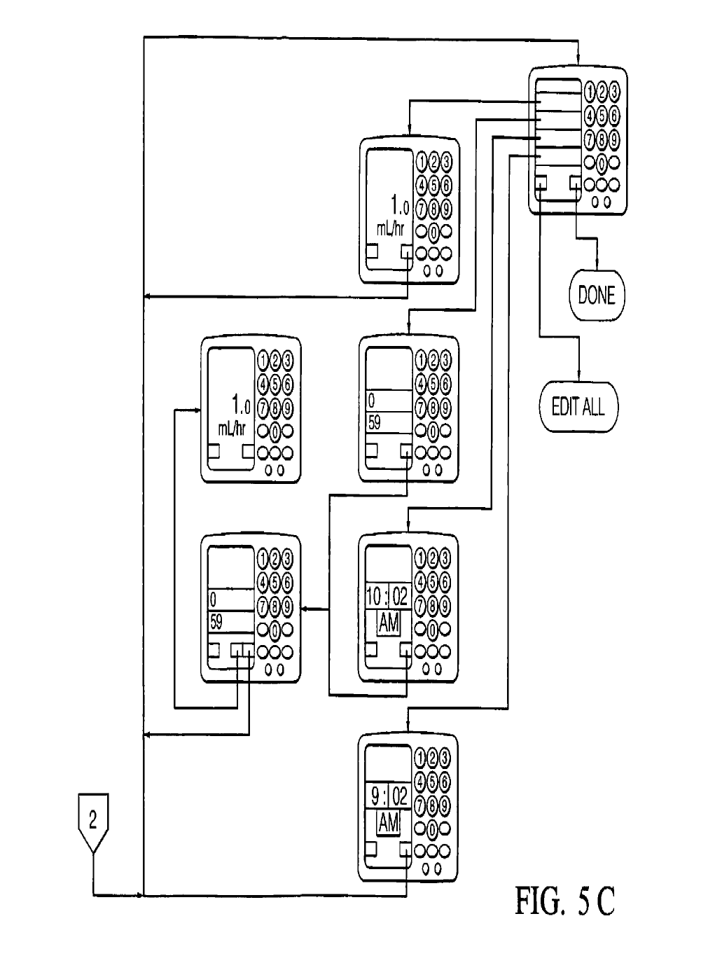

With reference now to FIGS. 5A-5C, if the user selects to delay the infusion, the user is asked whether he/she would like to edit the delay time according to a start time, or to a duration of the infusion. In either case, the user may enter/edit the hour, minutes and am/pm of the start time, the current time, and/or the delay time. The user is thereafter asked to confirm the infusion rate, which may be changed by the user if desired. The user is then presented with a review screen to confirm the new infusion rate, the delay time, the start time, and the current time (as shown in FIG. 5C). These variables may be edited by the user if desired.

Still with reference to FIGS. 5A-5C, if the user selects a multi-day infusion, the user will be prompted, on respective display screens, for a number of days to run the infusion. The user may thereafter select to begin infusion or to delay the infusion. If the user selects to delay the infusion, he/she will be presented with the display screens described above for inputting the current time, start time, and/or the delay time. If, however, the user selected to begin infusion, infusion commences immediately.

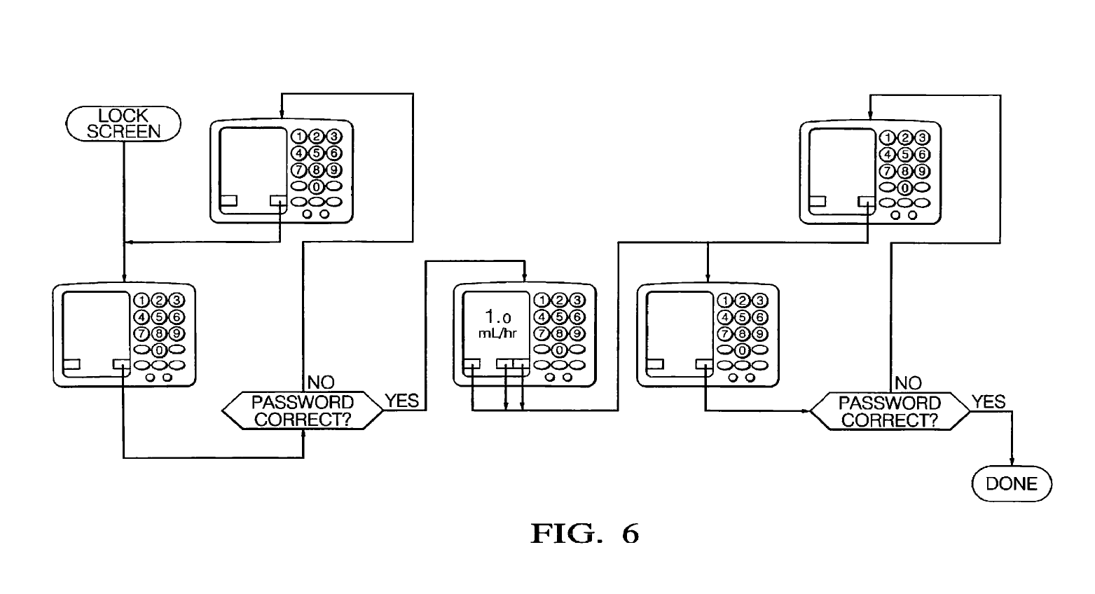

Referring back to FIGS. 4A-4C, once infusion has started, the user may select a function to i) lock the display screen, ii) pause the infusion, or iii) provide other infusion options. With reference now to FIG. 6, if the user selects to lock the display screen, the user will be presented with a screen asking for a lock-screen password. Locking the screen disallows the infusion settings from being changed during infusion. If the password is entered correctly, the display screen is locked throughout the entire infusion process. If the user wants to unlock the display screen at any time during the infusion, the user may do so by correctly entering an unlock password.

If the user selects to pause the infusion, the user will then be asked if he/she would like to quit the infusion or to resume the infusion. If the user selects to quit the infusion, the pump automatically turns off. If the user selects to resume infusion, the paused infusion process begins again.

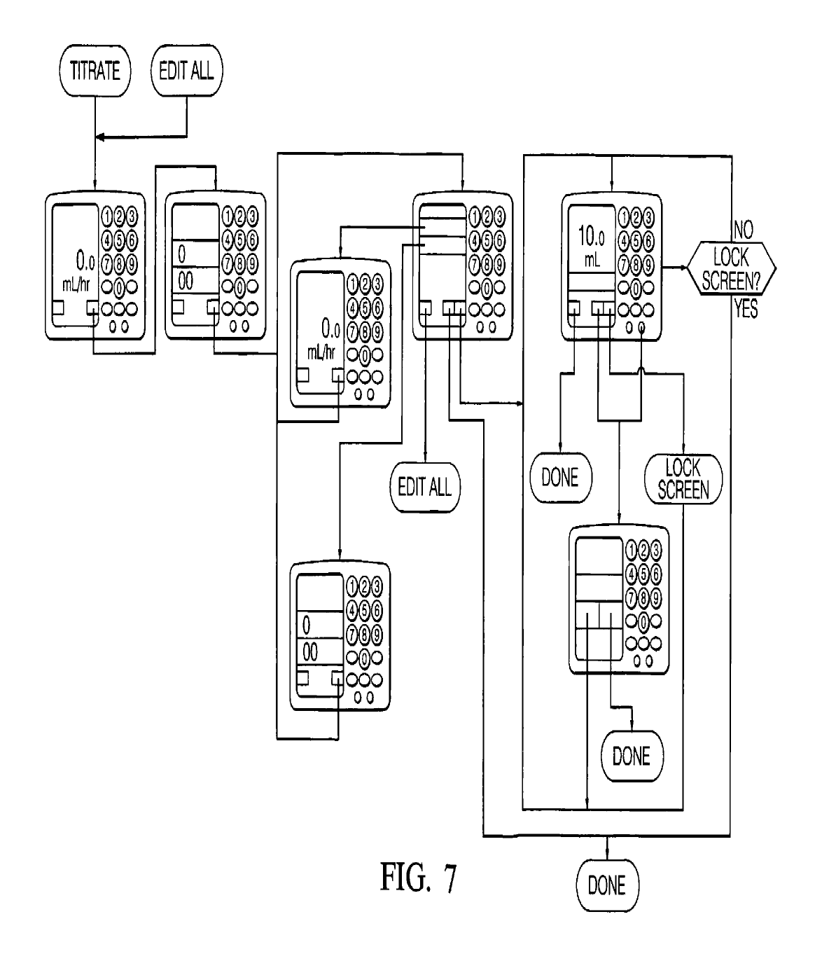

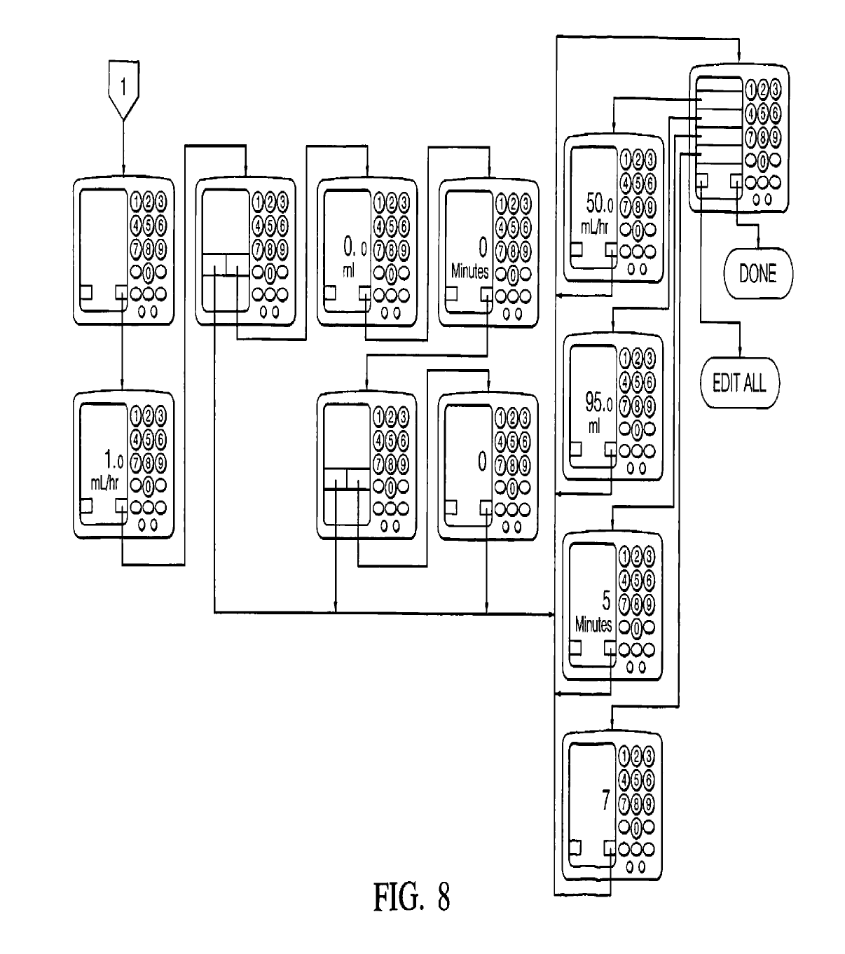

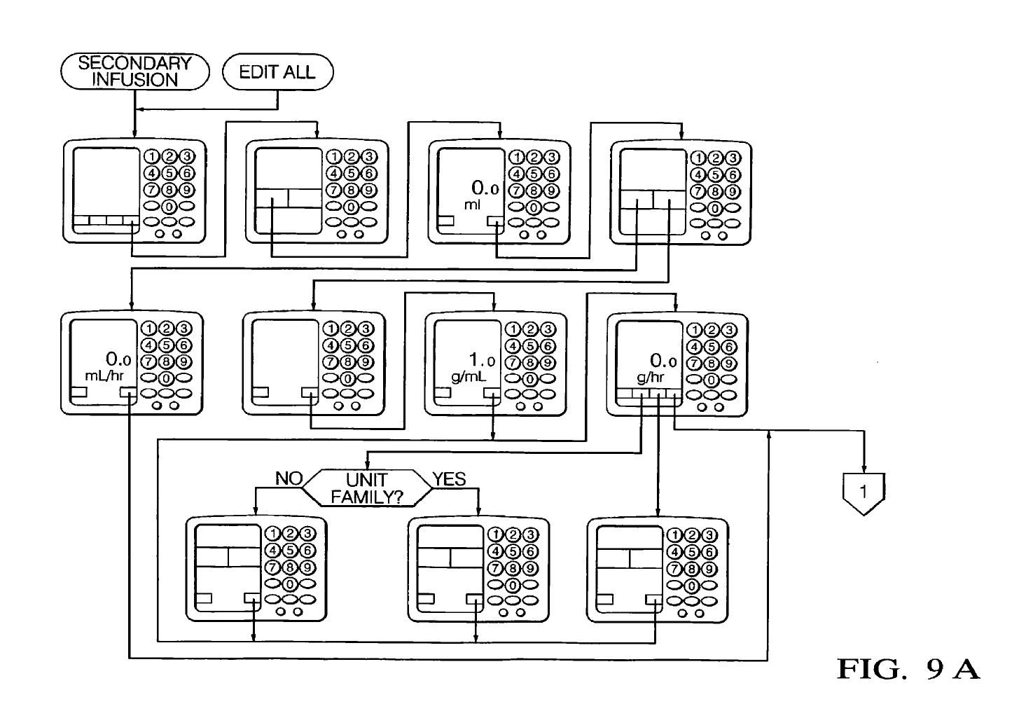

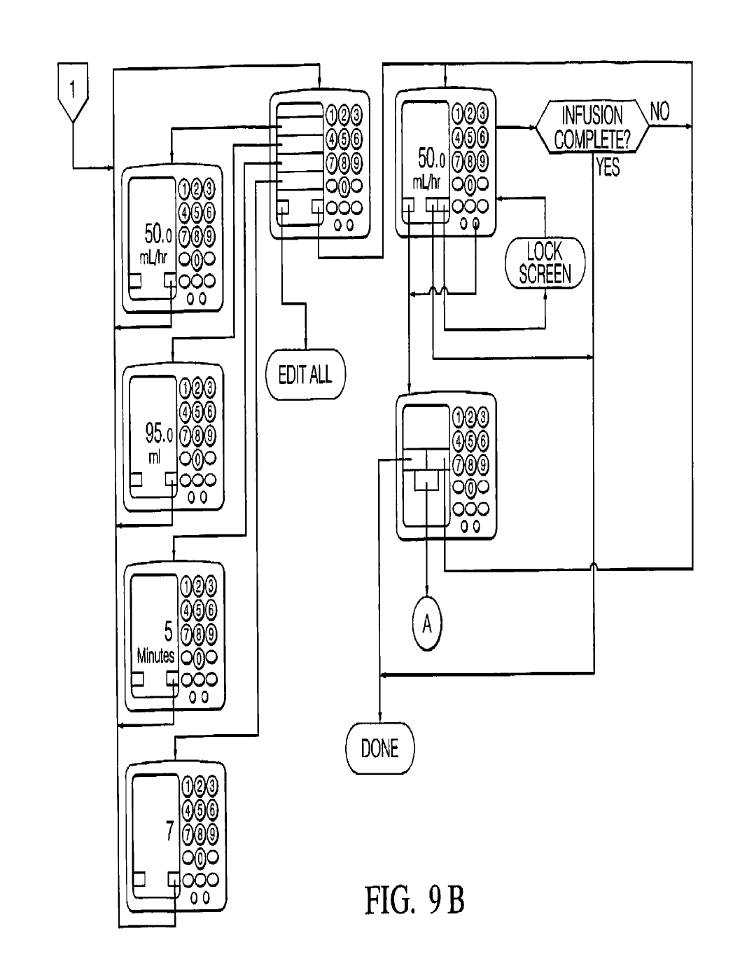

The other infusion options selection allows the user to select a titration function, a rate change function, or a secondary infusion function. As shown in FIG. 7, the titration function includes titrating the drug by entering a titration flow rate and a time limit for titrating. Further, as shown in FIG. 8, the rate change function includes infusing at a new rate by entering a new infusion rate. Yet further, as shown in FIGS. 9A-9B, the secondary infusion function includes entering a new volume of the drug to be infused, a new dosage amount, and a new infusion rate for the secondary infusion of the drug to the patient.

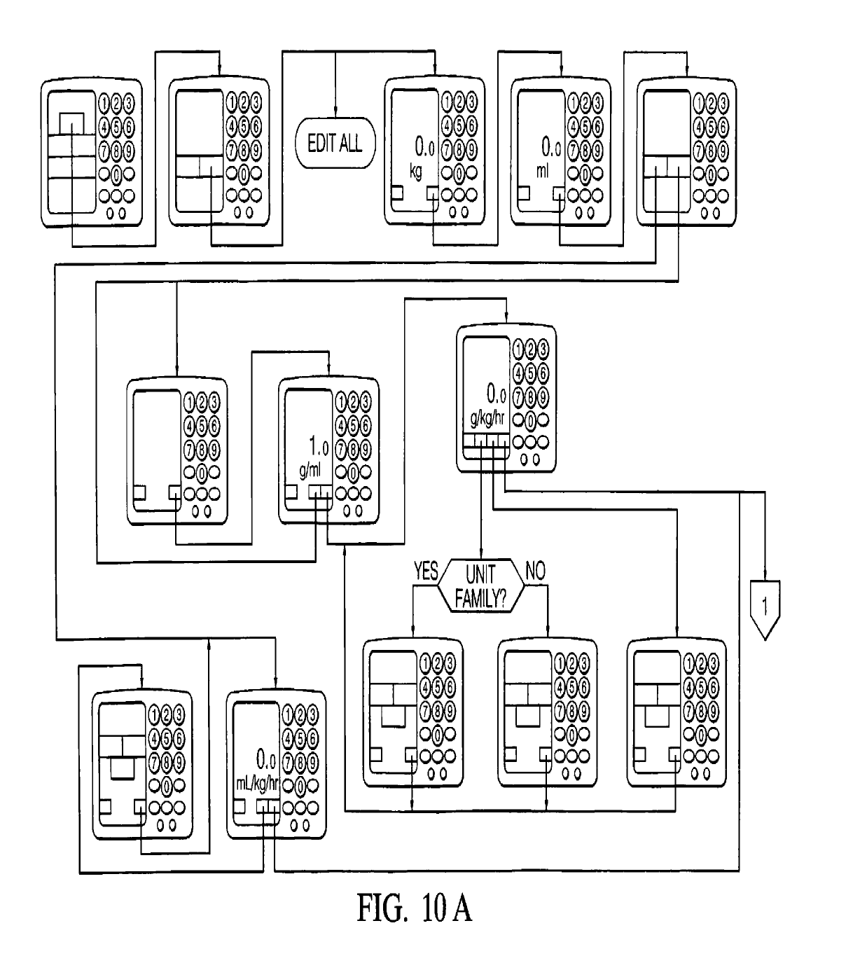

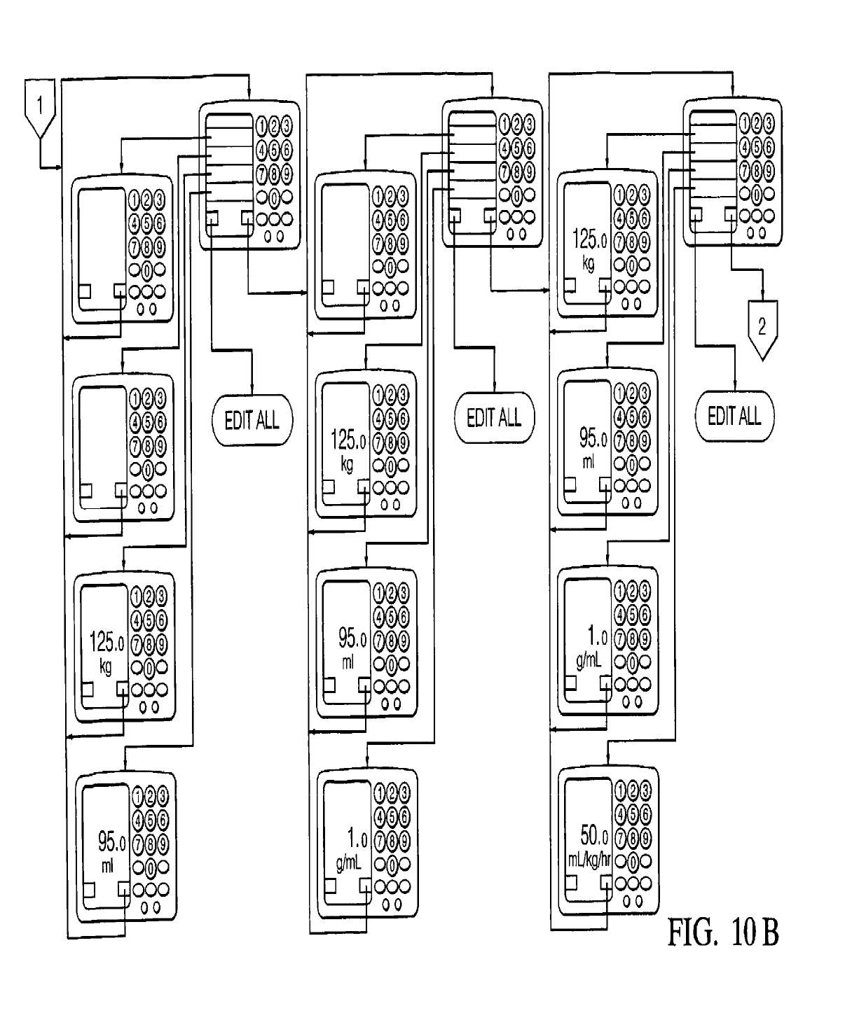

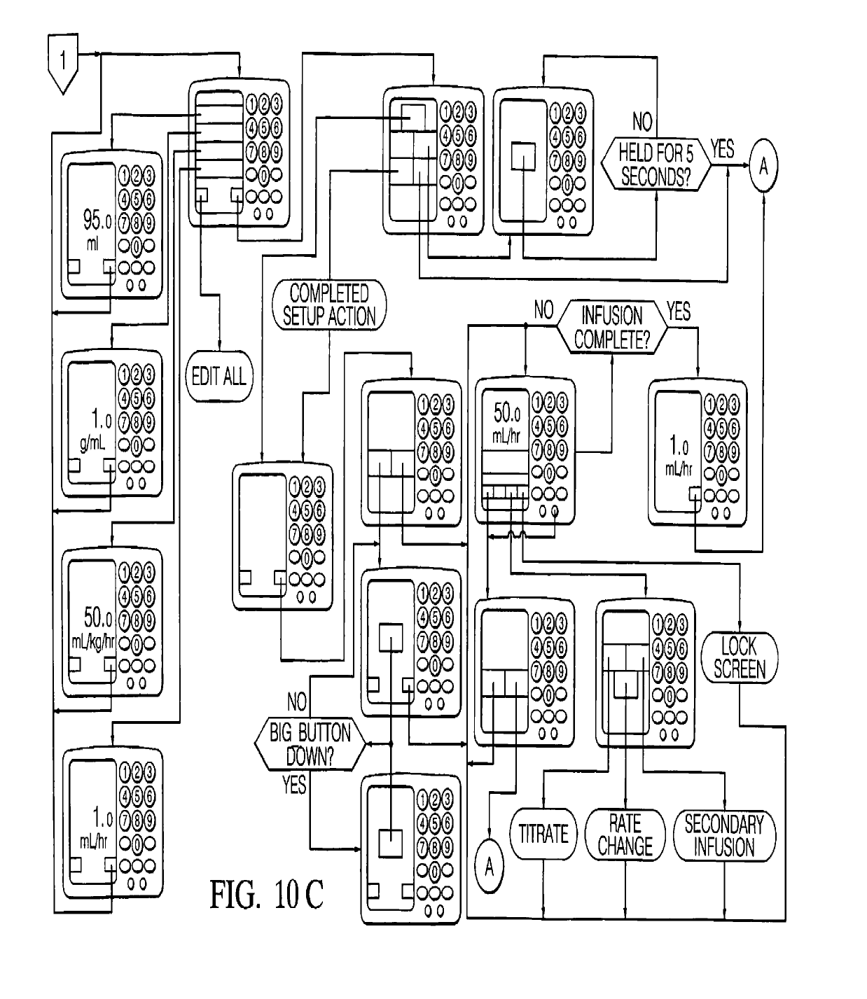

Referring now to FIGS. 10A-10C, manual data input for a weight-based continuous mode is shown. The manual data entry for the weight-based continuous mode follows substantially the same procedure as that for the non-weight-based continuous mode, except that a weight of the patient is also inputted into the infusion pump and provided on the review screen of the inputted data.

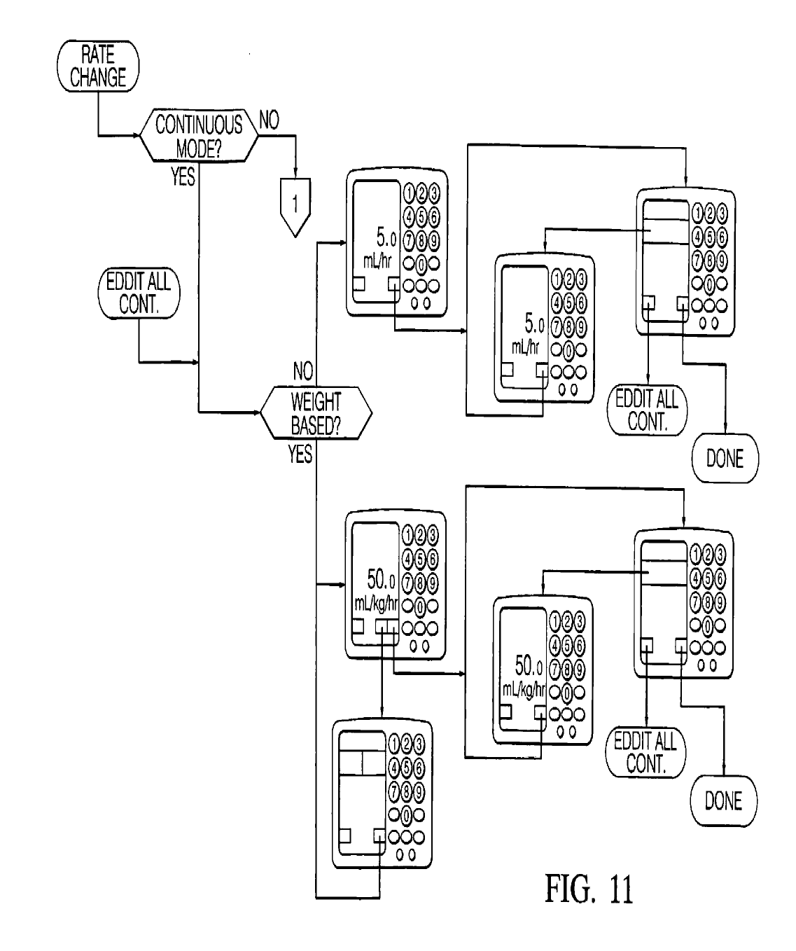

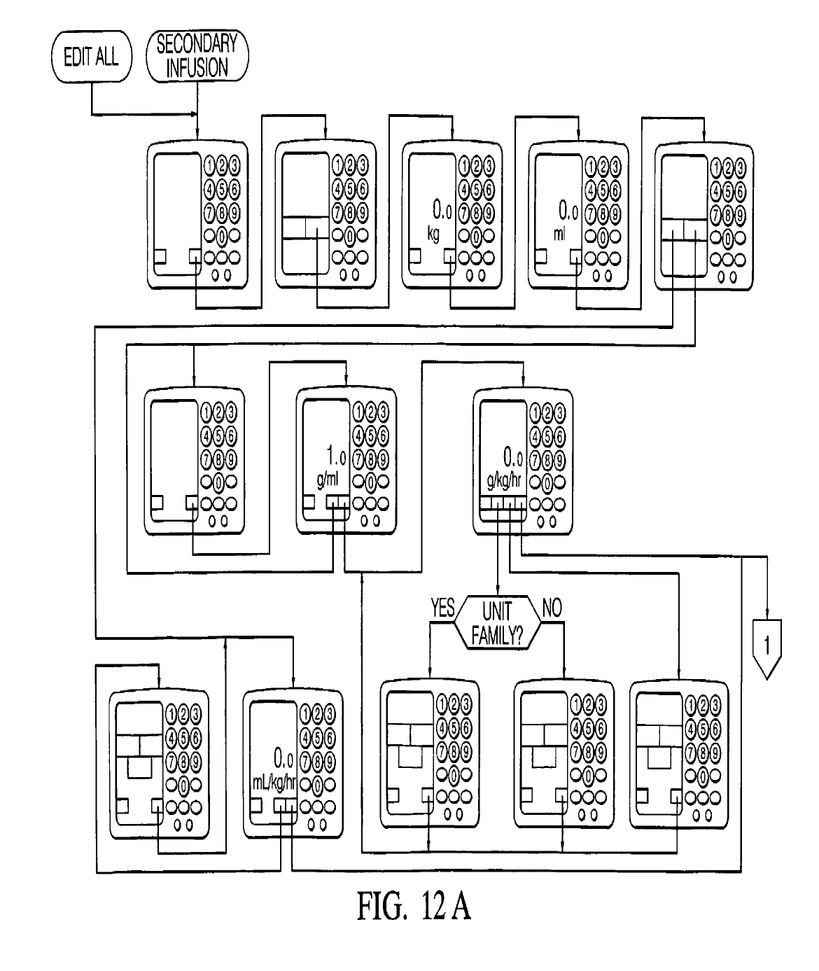

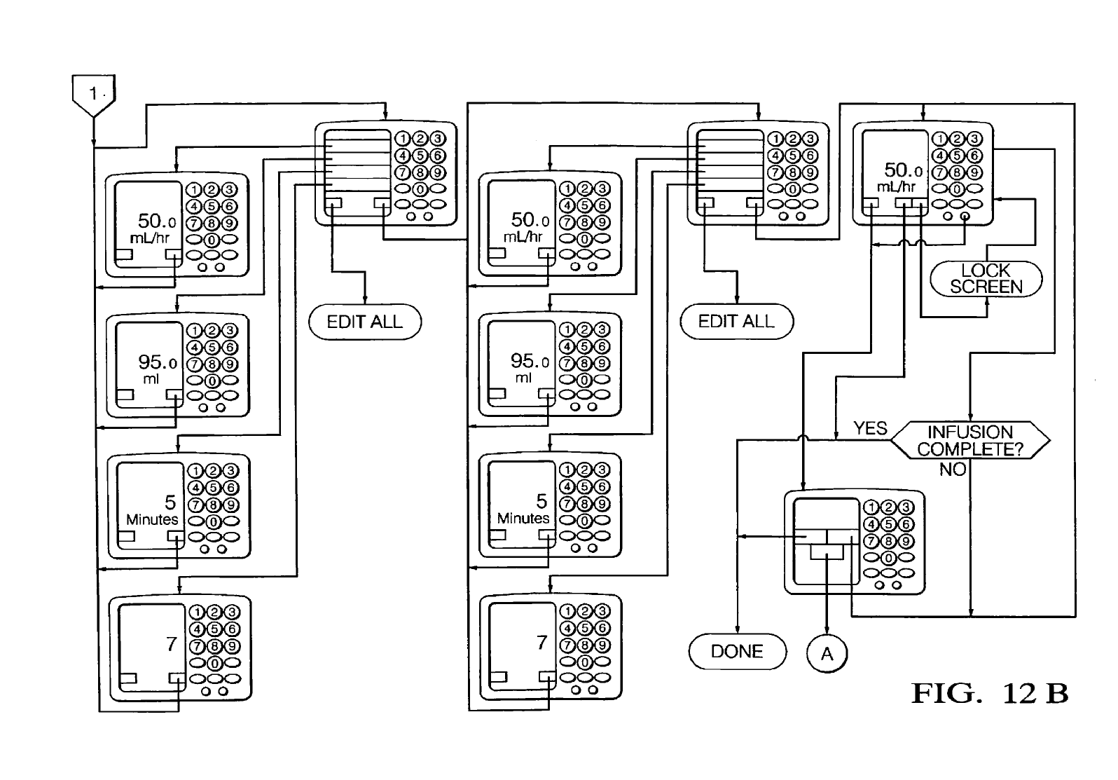

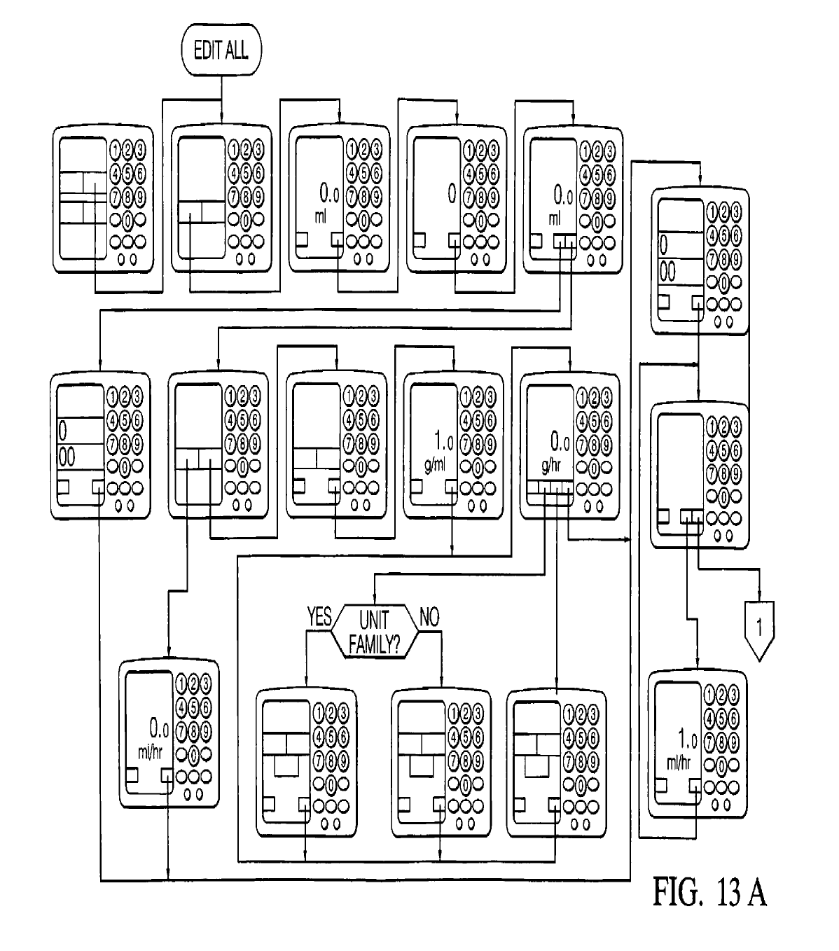

Inputting the data into the pump for the weight-based continuous mode further includes selecting i) to lock the display screen, ii) to pause the infusion, or iii) to provide other infusion options (as similarly provided for the non-weight-based continuous mode). The other infusion options include a titration function, a rate change function, and a secondary infusion function, The function to lock the display screen, to pause the infusion, and to titrate are the same as those previously described for the non-weight-based continuous mode in connection with FIGS. 4A-4C, 6, and 7. However, the rate change function for the weight-based continuous mode differs slightly from the non-weight-based continuous mode in that the dosage (and not the flow rate of the drug) is changed for the weight-based continuous mode (as shown in FIG. 11). Also, the secondary infusion function for the weight-based continuous mode differs slightly from the non-weight-based continuous mode in that the patient's weight is considered in addition to a new volume of the drug to be infused, a new dosage, and a new infusion rate (as shown in FIGS. 12A-12B).

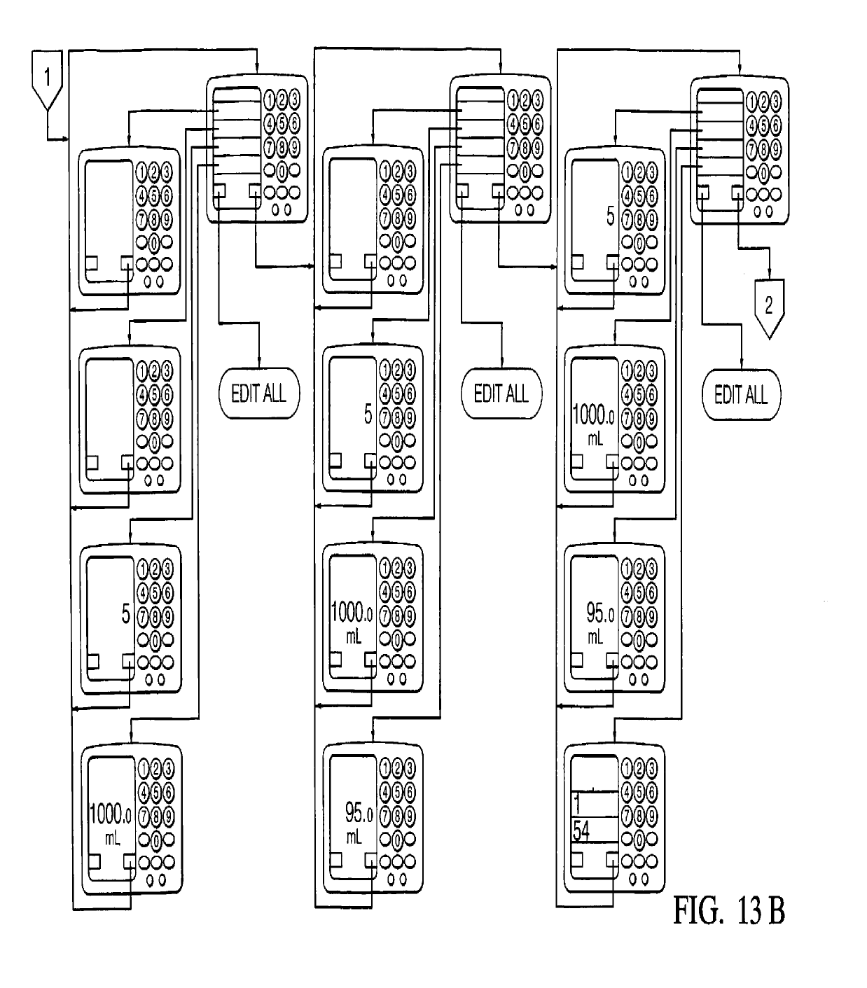

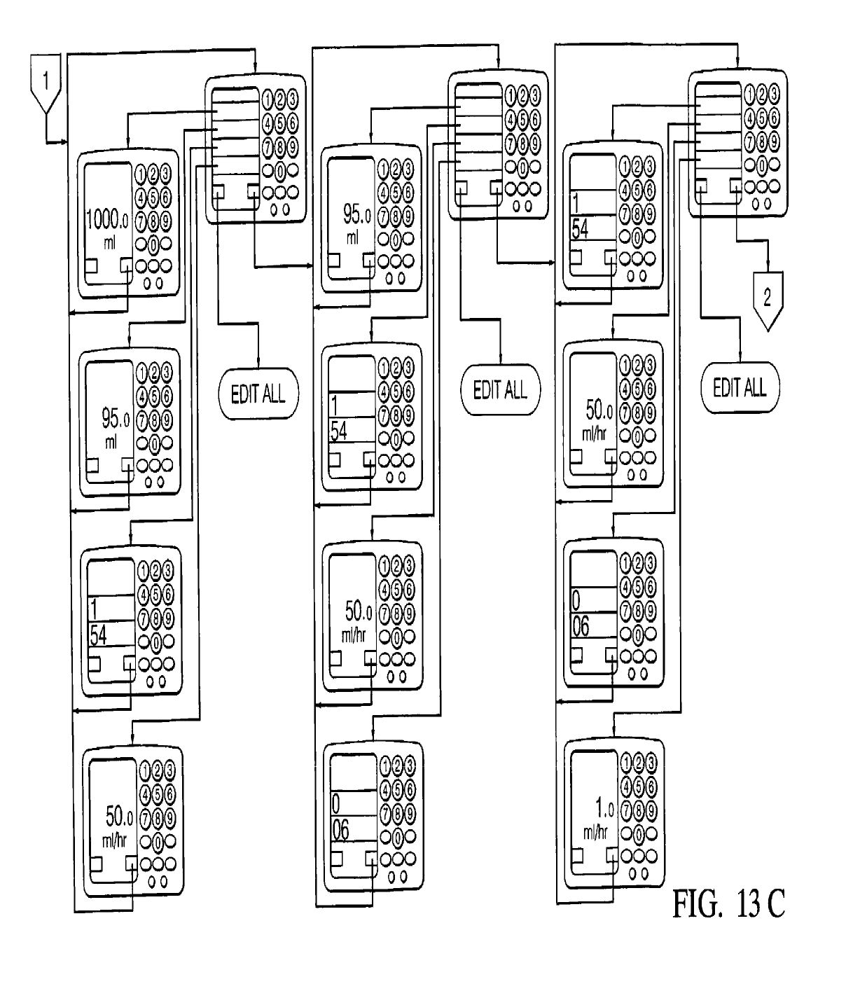

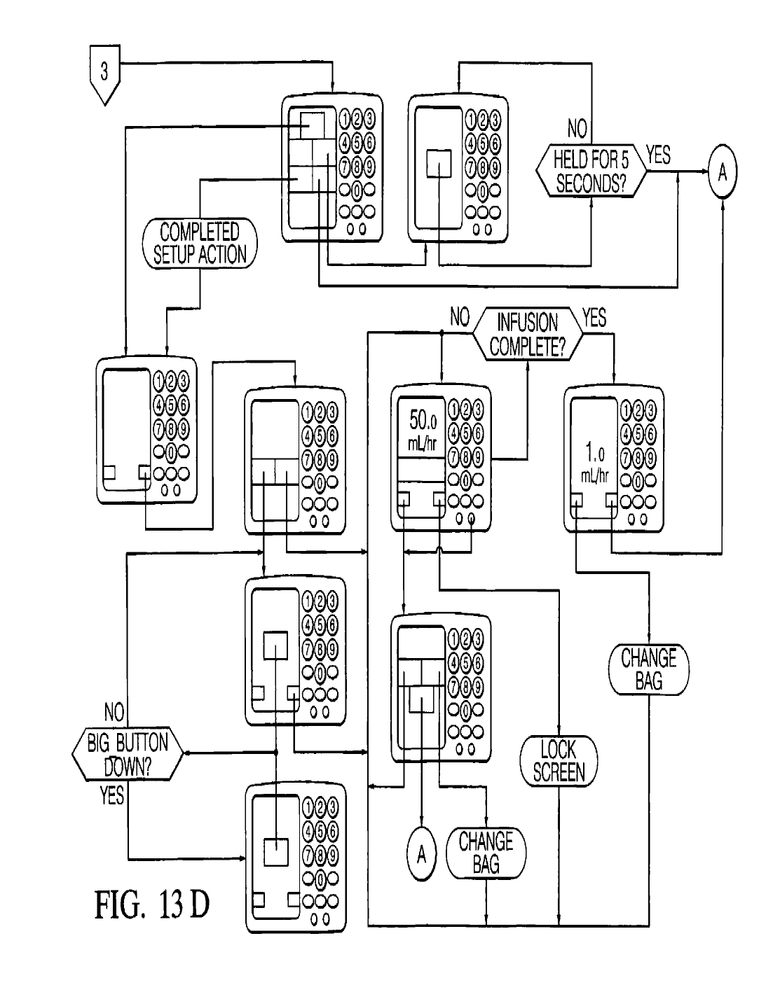

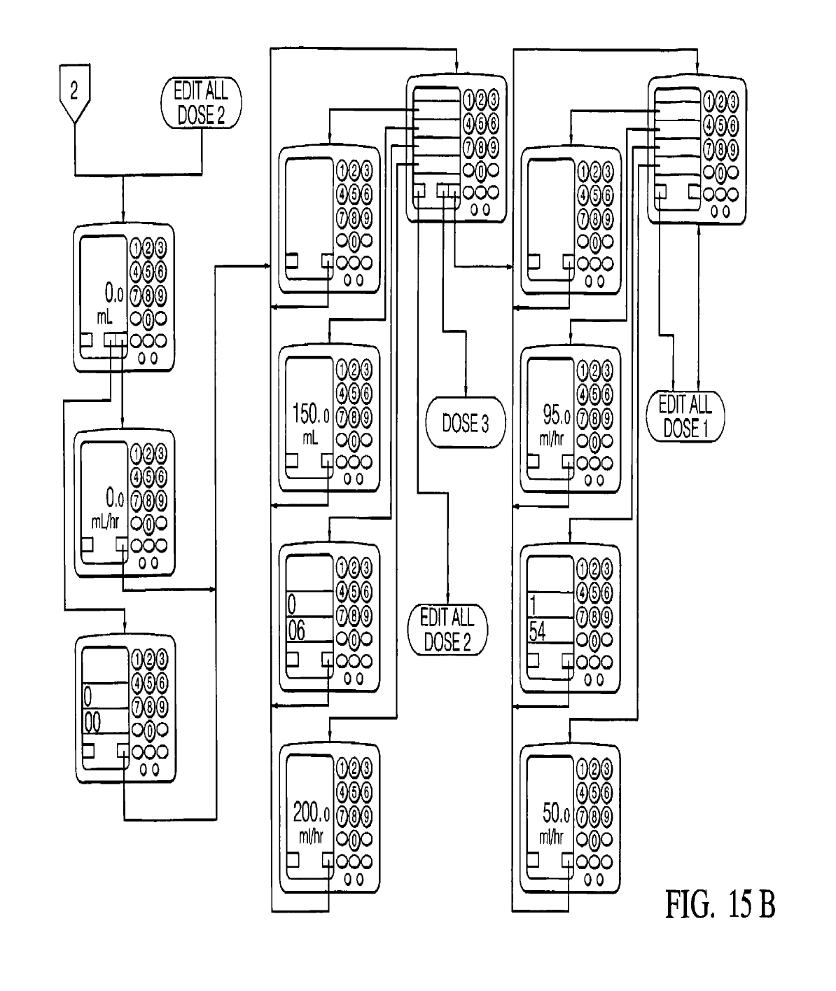

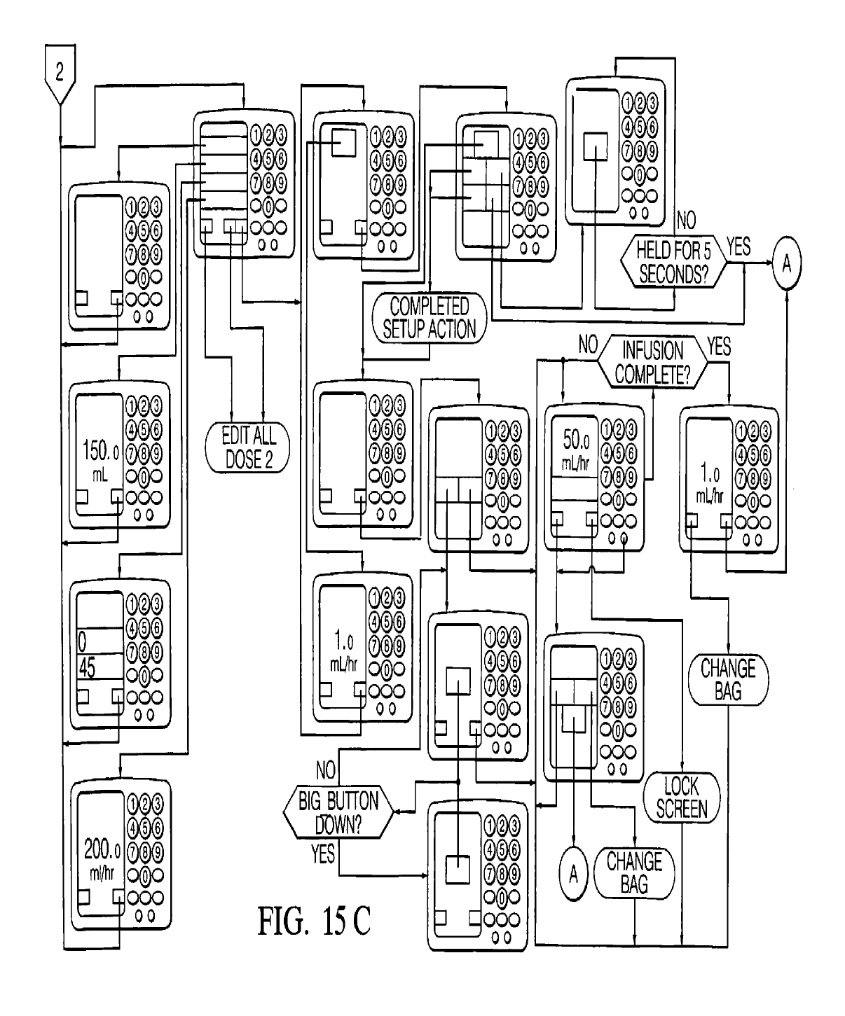

Manual data input for an intermittent, dose-based mode is shown in the flow diagrams depicted in FIGS. 13A-13D, and manual data input for an intermittent, multi-step mode is shown in the flow diagrams depicted in FIGS. 15A-15C. Starting with the dose-based intermittent mode, in an embodiment, infusion parameters input into the pump include a number of doses, a dosage amount, a duration for each dose, a delay time between each dose, and an infusion rate. In another embodiment, a concentration of the drug is also input into the pump. These parameters, including the patient's name are thereafter provided for the user's review and/or edit on a review screen.

When the user is finished reviewing and/or editing the information, the user may select to begin the infusion. If the user selects to begin the infusion, the user is presented with a series of display screens for i) confirming that an occlusion slider for the cassette is in a non-occluded position, ii) determining whether the pump is primed, and iii) priming the pump in the event that pump is not primed. The infusion thereafter commences.

The user is, however, also presented with other alternatives pertaining to starting the infusion. These choices include a save option, a multi-day infusion option, a delay infusion option, or a quit option (similar to those previously described).

Referring now to FIG. 13D, once infusion has started, the user may select a function to i) lock the display screen or ii) pause the infusion. If the user selects to pause the infusion, the user is presented with a number of options including i) to resume infusion, ii) to quit infusion, or iii) to change the drug bag or reservoir.

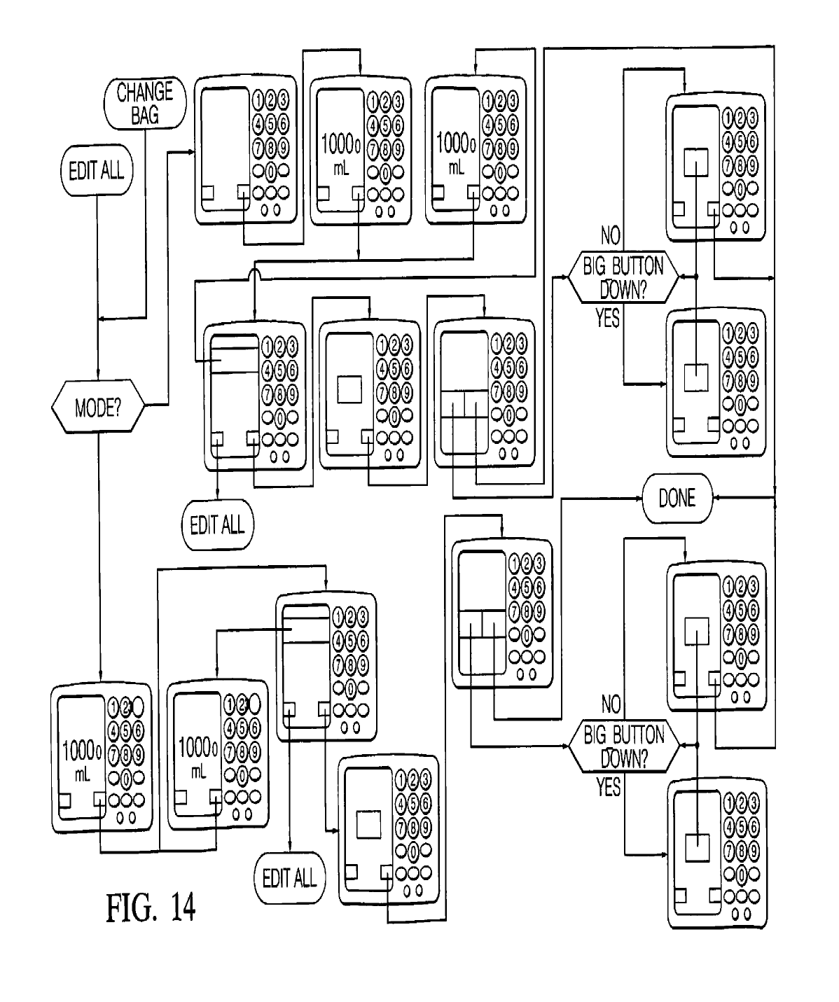

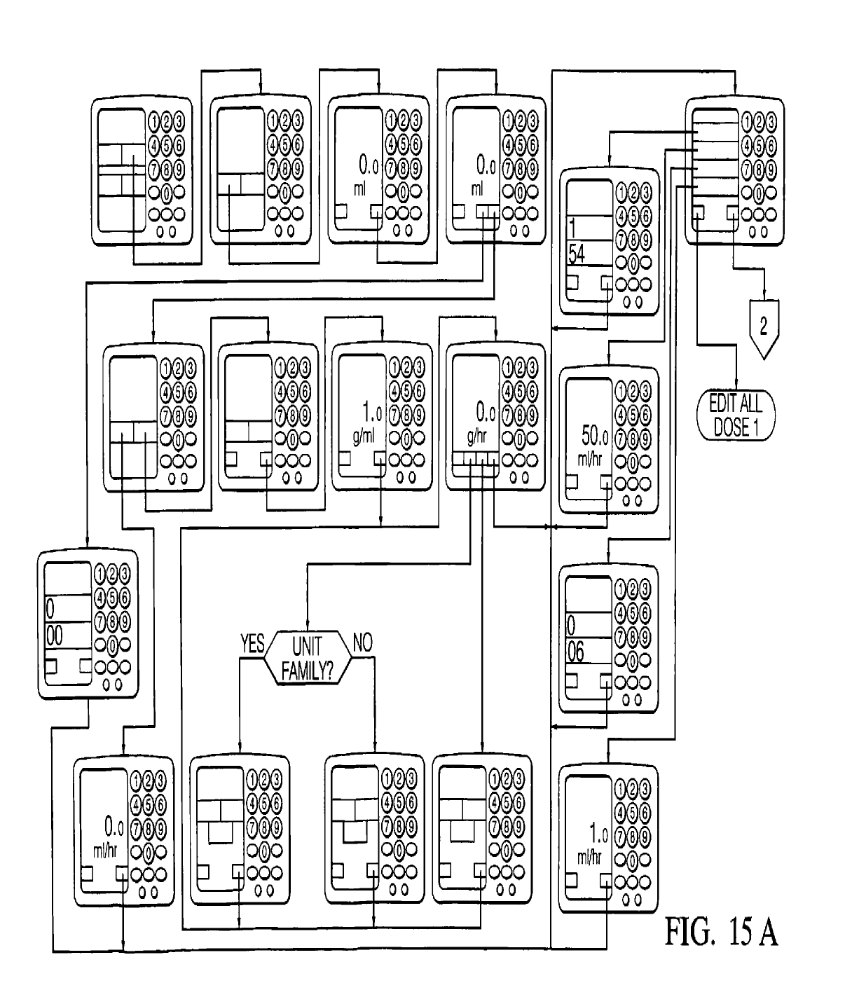

Referring now to FIG. 14, if the user selects to change the drug bag, he/she will be presented with a new screen asking for a new reservoir volume and, thereafter, a review screen for confirming accuracy of the new reservoir volume. The user is also asked whether the infusion pump is primed and, if not, is presented with a series of screens for priming the pump. Thereafter, infusion may commence with the newly changed drug bag.

For manual data input for an intermittent, multi-step mode, infusion parameters inputted into the pump include a volume of the reservoir including the drug, a dosage amount with the infusion time and infusion rate associated therewith, and another dosage amount with another infusion time and another infusion rate associated therewith. In another embodiment, a concentration of the drug is also inputted into the pump. These parameters, including the patient's name, are thereafter provided for the user's review and/or edit on a review screen.

When the user is finished reviewing and/or editing the patient's name, the drug name, and/or the infusion parameters, the user may select to begin the infusion. If the user selects to begin the infusion, the user is presented with a series of display screens for i) confirming that an occlusion slider for the cassette is in a non-occluded position, ii) determining whether the pump is primed, and iii) priming the pump in the event that pump is not primed. The user is also presented with other choices related to starting the infusion. These choices include a save option, a multi-day infusion option, a delay infusion option, or a quit option.

Referring now to FIG. 15C, once infusion has started, the user may select a function to i) lock the display screen or ii) pause the infusion. If the user selects to pause the infusion, the user is presented with a number of options including i) to resume infusion, ii) to quit infusion, or iii) to change the drug bag or reservoir. Referring back to FIG. 14, if the user selects to change the drug bag, he/she will be presented with a new screen asking for a new reservoir volume and, thereafter, a review screen for confirming accuracy of the new reservoir volume (as similarly described above). In some instances, the user will also be asked to provide a security code or password that, if correct, allows the user to change the bag or reservoir.

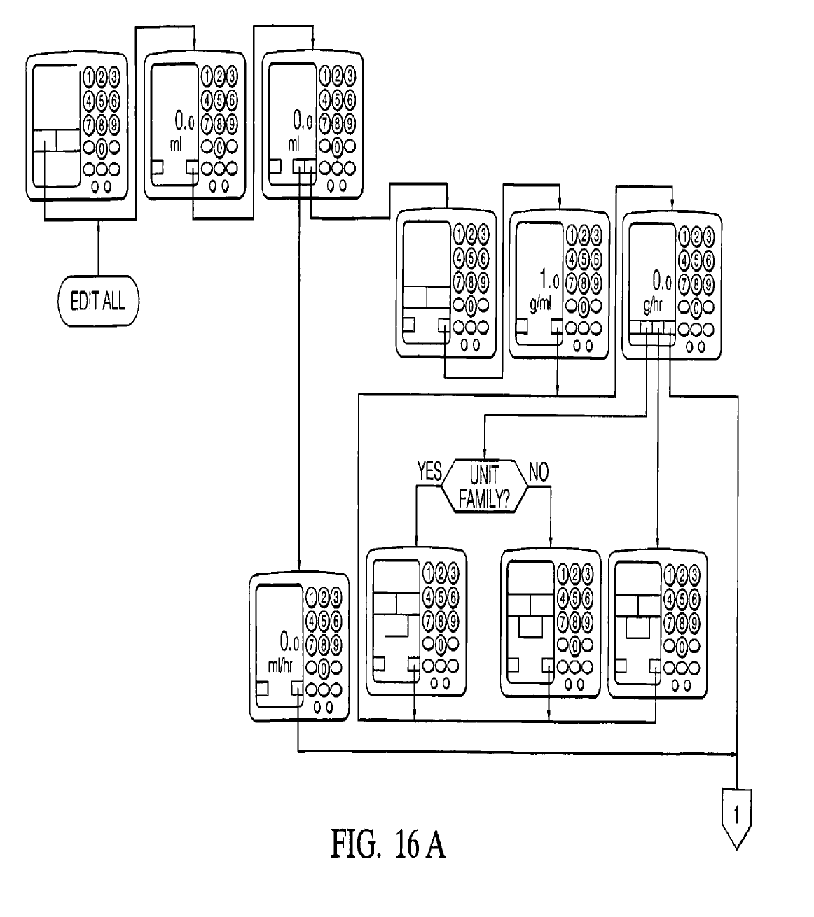

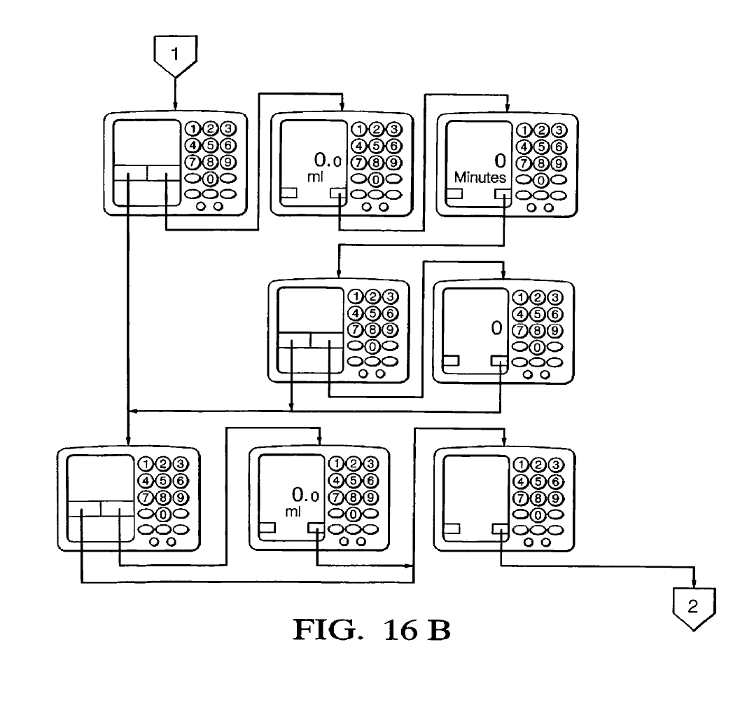

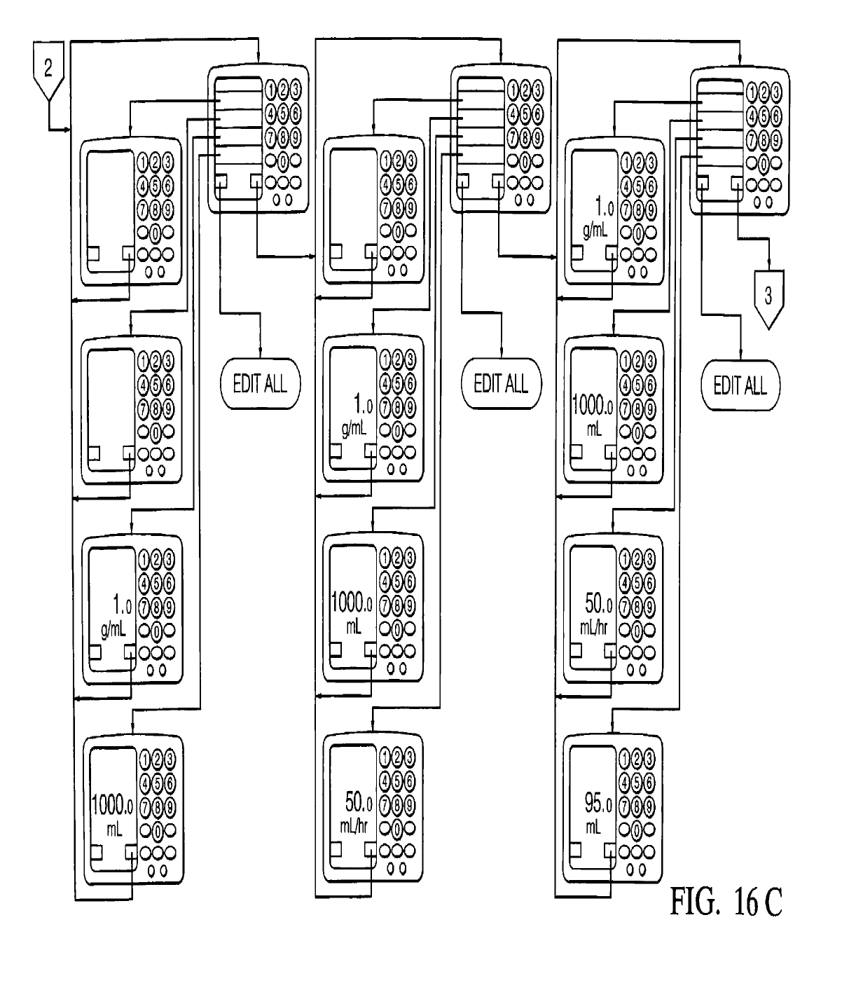

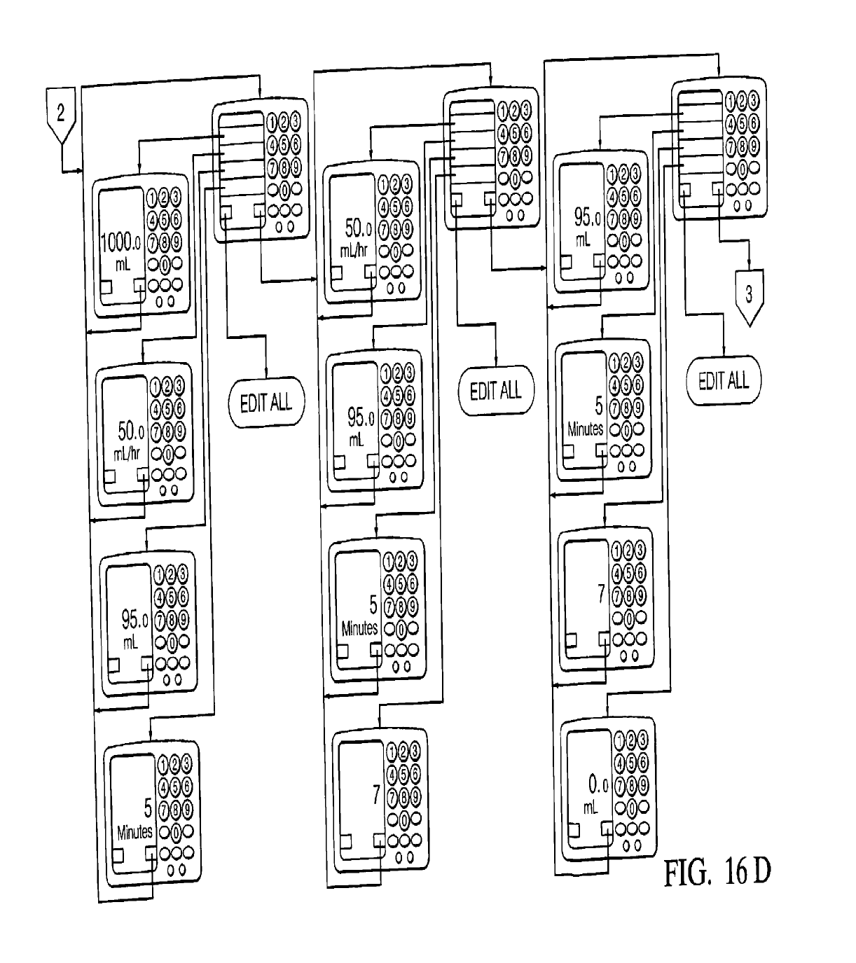

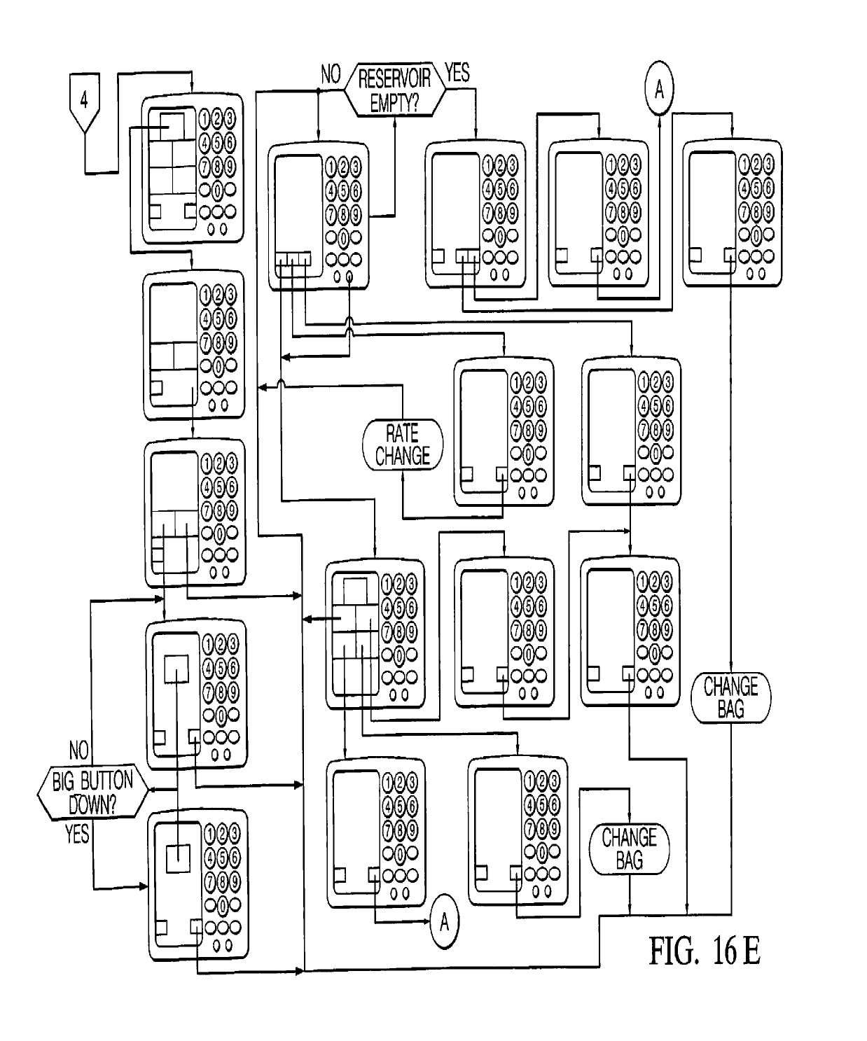

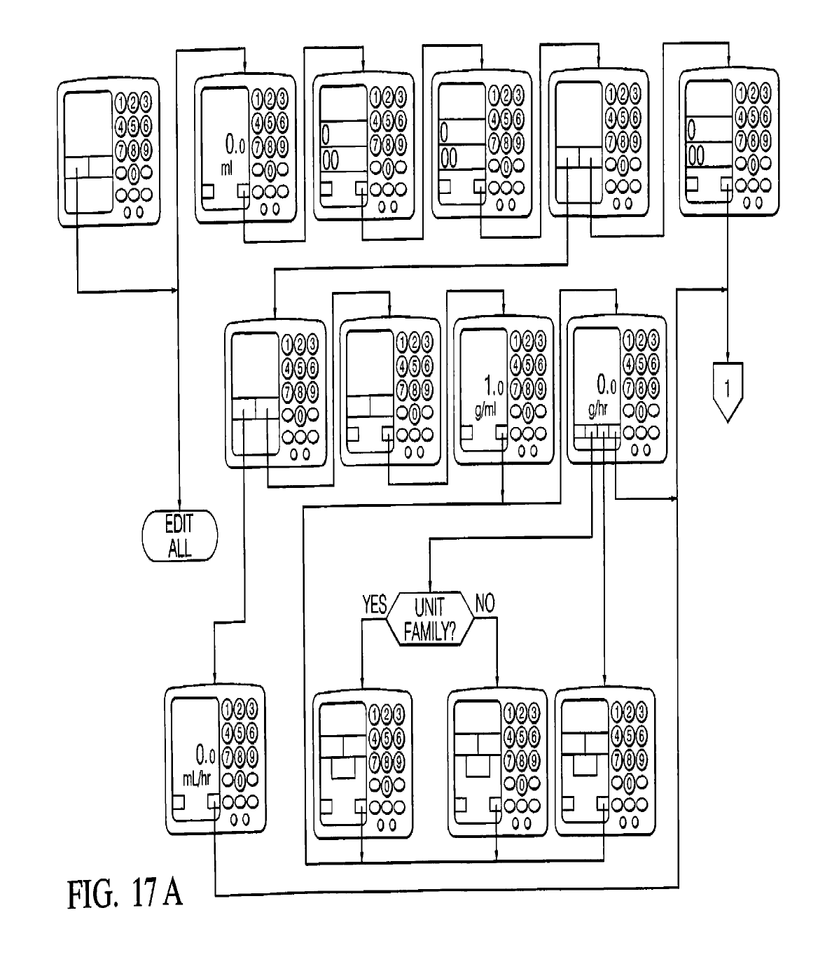

Manual data input for PCA mode is shown in the flow diagrams depicted in FIGS. 16A-16E. For the PCA mode option, the user will be prompted to enter a reservoir volume and then will be prompted as to whether he/she will use a bolus dose and/or a loading dose. If a bolus dose will be used, the user enters the bolus dose. In some cases, the user may also be asked to provide a lockout time. The user is then asked if the number of doses is limited based on time and, if so, the user enters a maximum number of doses per that time. If, however, a loading dose is used, the user enters the loading dose into the pump. In some instances, a concentration of the drug is also inputted into the pump. These parameters, including the other parameters, such as the patient's name, are thereafter provided for the user's review and/or edit on a review screen. In another embodiment, the user is also prompted to enter a concentration for the drug.

When the user is finished reviewing and/or editing the patient's name, the drug name, and/or the infusion parameters, the user may select to begin the infusion. If the user selects to begin the infusion, the user is presented with a series of display screens for i) confirming that an occlusion slider for the cassette is in a non-occluded position, ii) determining whether the pump is primed, and iii) priming the pump in the event that pump is not primed. The infusion thereafter commences.

Once the infusion has started, the user may choose to pause the infusion. When the infusion is paused, the user is presented with a number of options including i) to resume infusion, ii) to quit infusion, iii) to change the drug bag or reservoir (the method of which is described above in connection with FIG. 14), or iv) to provide a bolus count. If the option for providing a bolus count is selected, a new screen including bolus information for the instant infusion is presented to the user. In some instances, the pump may also ask for a security code from the user to ensure that the user is permitted to change any of the infusion parameters.

Referring back to FIG. 8, during infusion, the user may select to change the bolus flow rate and enter a new basal flow rate. The user will be prompted with a question related to whether a new dose is also needed. If so, the user enters a new dose and a new lock-out time. In an embodiment, the new dose may be limited based on time. If this is the case, a new maximum dose per time may be entered into the pump.

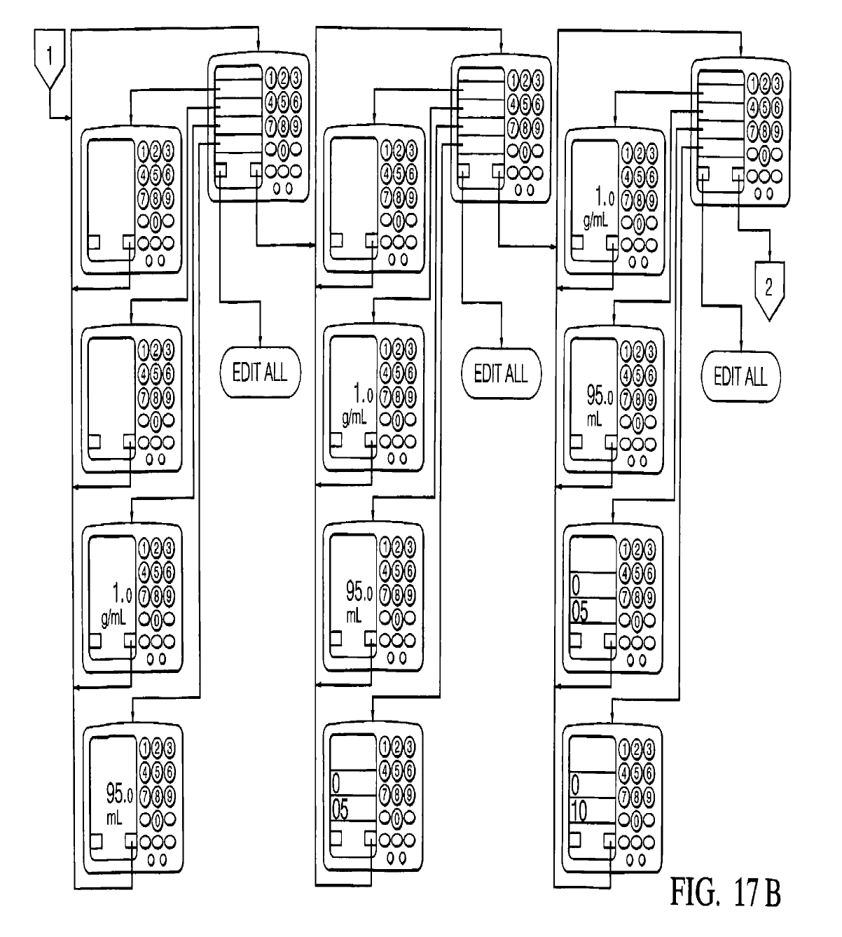

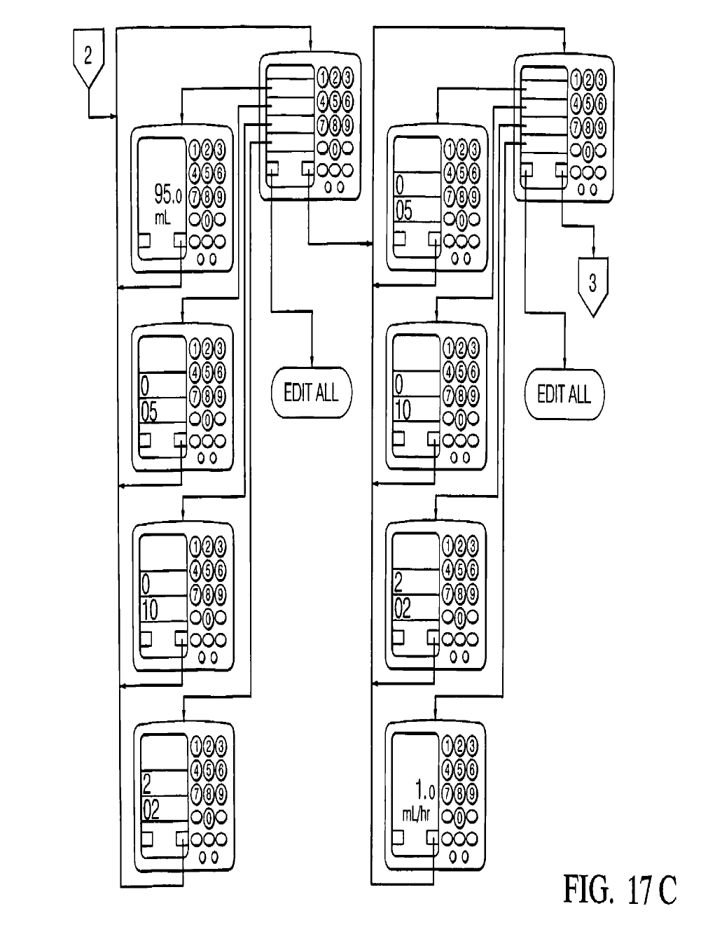

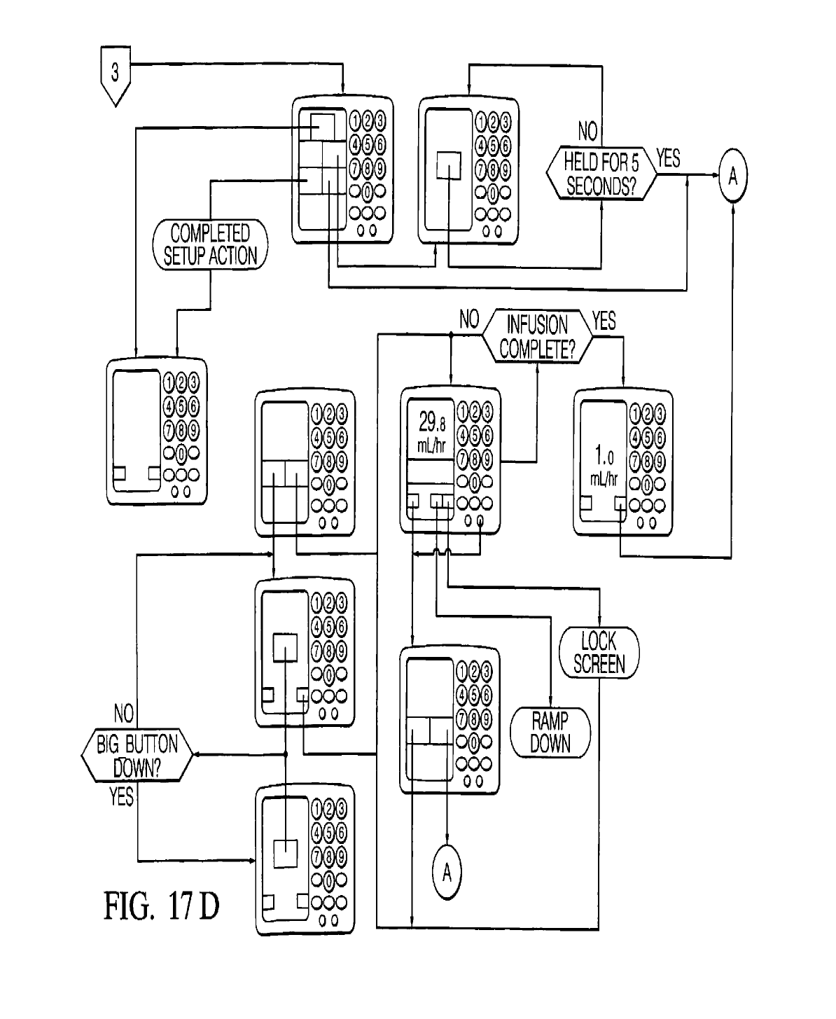

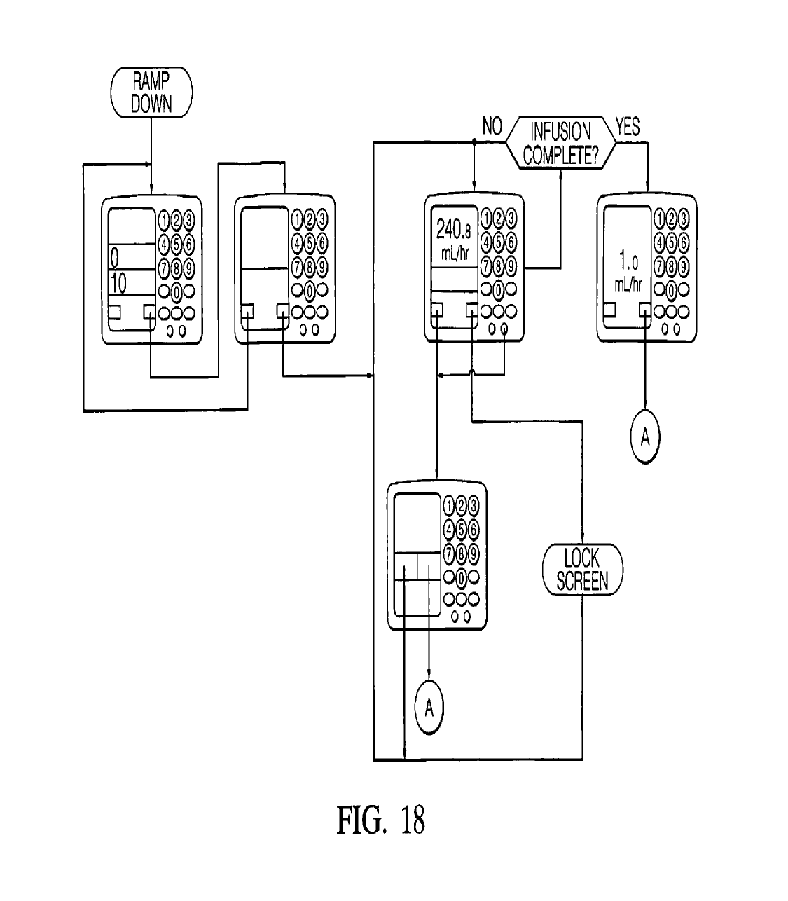

Manual data input for TPN mode is shown in the flow diagrams depicted in FIGS. 17A-17D. For the TPN mode, infusion parameters including a volume of the drug to be infused and a ramp up and down time are inputted into the pump. In an embodiment, a concentration of the drug is also inputted into the pump. The user may then select a desired infusion mode based on a rate of infusing the drug or based on a time for infusing the drug. If the infusion mode is based on the rate, then the user enters the concentration of the drug and the dose. If, however, the infusion mode is based on time, then the user enters a total time for infusing the drug. These parameters are thereafter provided for the user's review and/or edit on a review screen.

When the user is finished reviewing and/or editing the patient's name, the drug name, and/or the infusion parameters, the user may select to begin the infusion. If the user selects to begin the infusion, the user is presented with a series of display screens for i) confirming that an occlusion slider for the cassette is in a non-occluded position, ii) determining whether the pump is primed, and iii) priming the pump in the event that pump is not primed. The infusion thereafter commences.

Once the infusion has started, the user may select to either pause the infusion or to ramp down the infusion rate based on time. As shown in FIG. 18, the flow rate of the drug is ramped down by inputting a ramp down time.

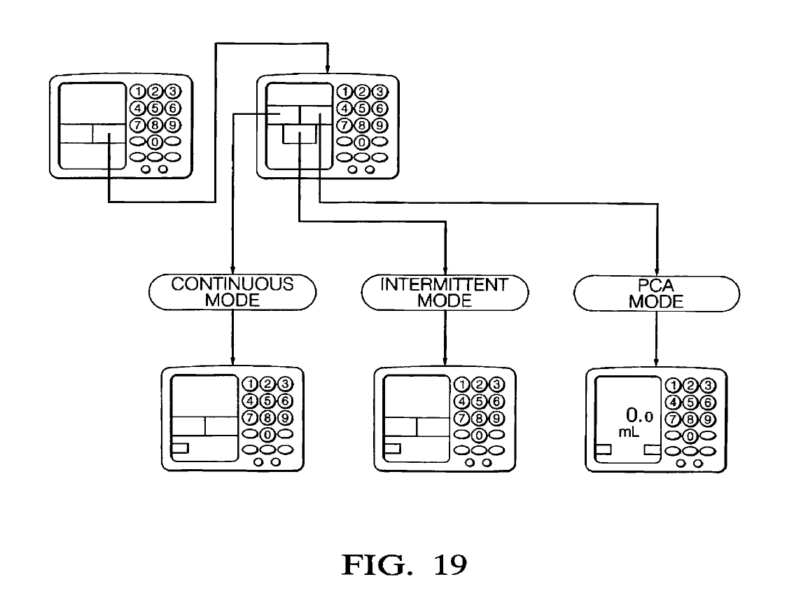

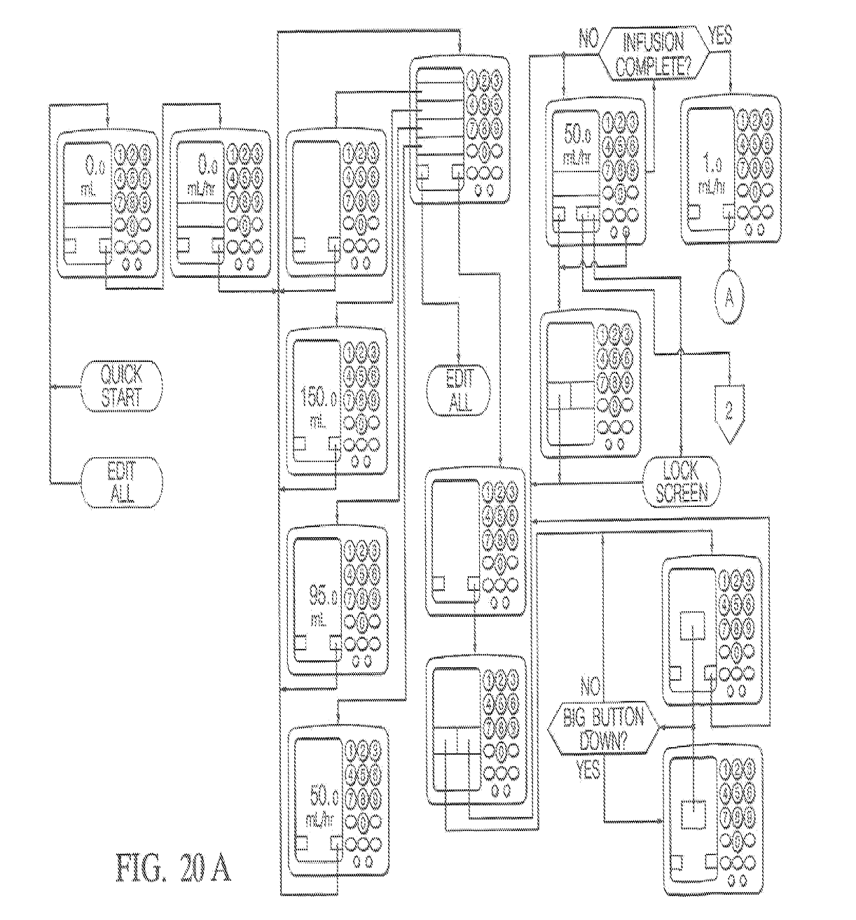

FIG. 19 provides a flow diagram depicting an epidural mode. In this embodiment, the epidural mode is selected from the introductory screen on the display. The user is then presented, on another display screen, with delivery options including a continuous mode, a PCA mode, and an intermittent mode. The continuous mode, if selected, is described above in connection with FIGS. 4A-4C and FIGS. 10A-10C. The PCA mode, if selected, is described above in connection with FIGS. 16A-16E. The intermittent mode is described above in connection with FIGS. 13A-13D and FIGS. 15A-15C.

It is to be understood that each of the infusion modes presented to the user (i.e., the continuous mode, the intermittent mode, the PCA mode, the TPN mode, and the epidural mode) may be identified by a separate color on the display. For example, the landscape of each screen presented to the user for, e.g., the continuous mode will be blue, while the landscape for each screen presented to the user for, e.g., the intermittent mode will be green. This color coding allows the user to recognize which infusion mode they are operating as data is entered into the pump and after infusion starts. Furthermore, if the user is operating the pump in an epidural mode, the screen is a different color than for the other modes, even if the user selected an epidural, continuous delivery of the drug to the patient. This notifies the user that an epidural injection is occurring, as opposed to an intravenous injection. It is further to be understood that the color scheme provided above is merely for exemplary purposes and that any color scheme may suitably be applied.

To reiterate from above, and with reference again to FIG. 2, if the patient is not a new patient, the infusion protocol for the patient may already be saved on the pump. To retrieve the infusion protocol, in an example, the user selects to repeat the infusion and may then be prompted to confirm the patient's name. If the patient's name is correct, the saved infusion protocol (which in many instances is the previous infusion) will be loaded by the pump.

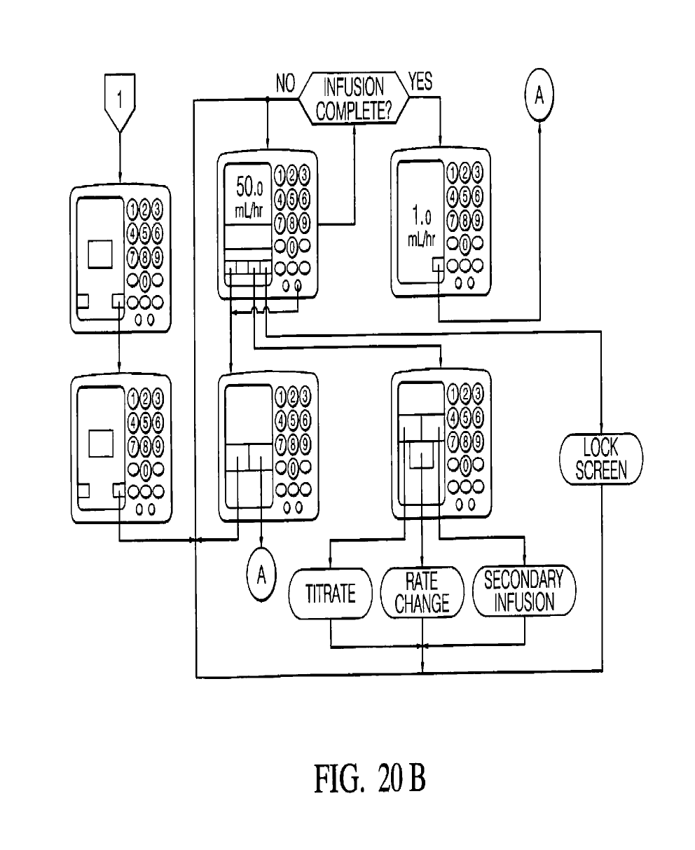

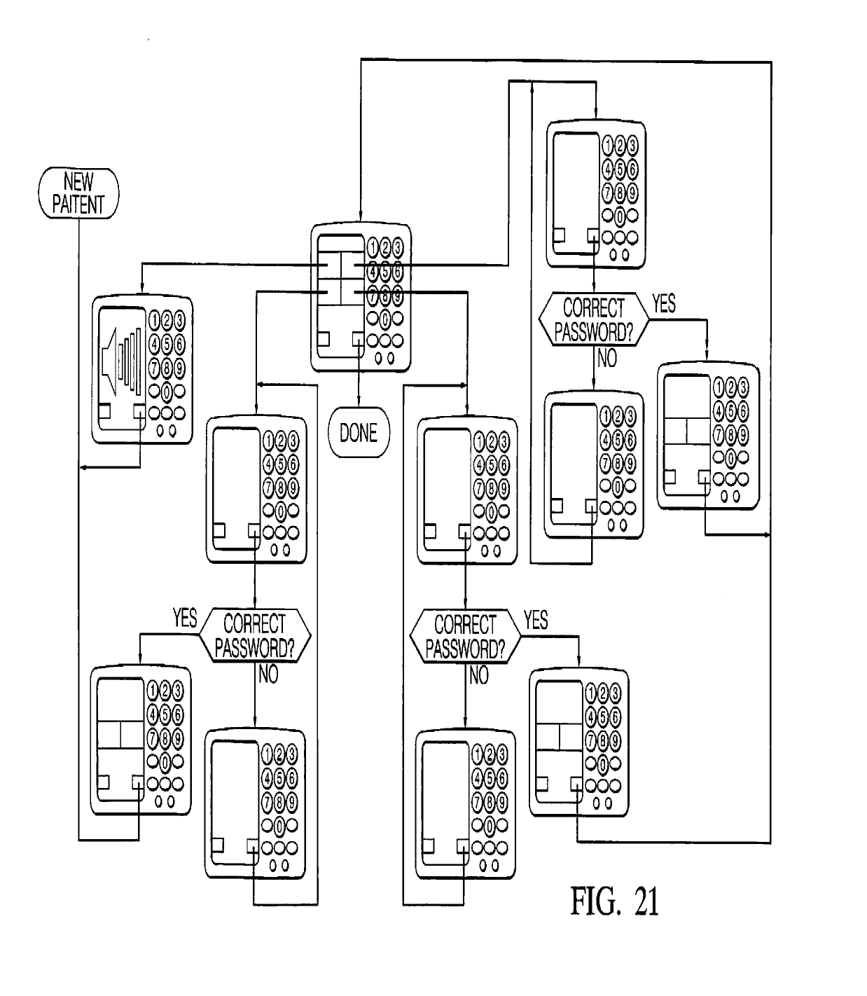

Further, if the patient is not a new patient, the user may select the quick start mode, which allows the pump to be quickly programmed for the instant infusion. A flow diagram of the quick start mode is depicted in FIGS. 20A-20B. During the quick start mode, many screens for inputting the infusion parameters are bypassed because the pump already has the information in a previously saved profile. Prior to infusing the drug, the user is presented with a review screen to confirm the accuracy of the saved infusion parameters.

In an example, the user may also select to change one or more pump options. Examples of pump options include a volume level, an air-in-line trigger, an occlusion trigger, a downstream occlusion retry, and/or the like. A flow diagram depicting changing the pump options is shown in FIG. 21.

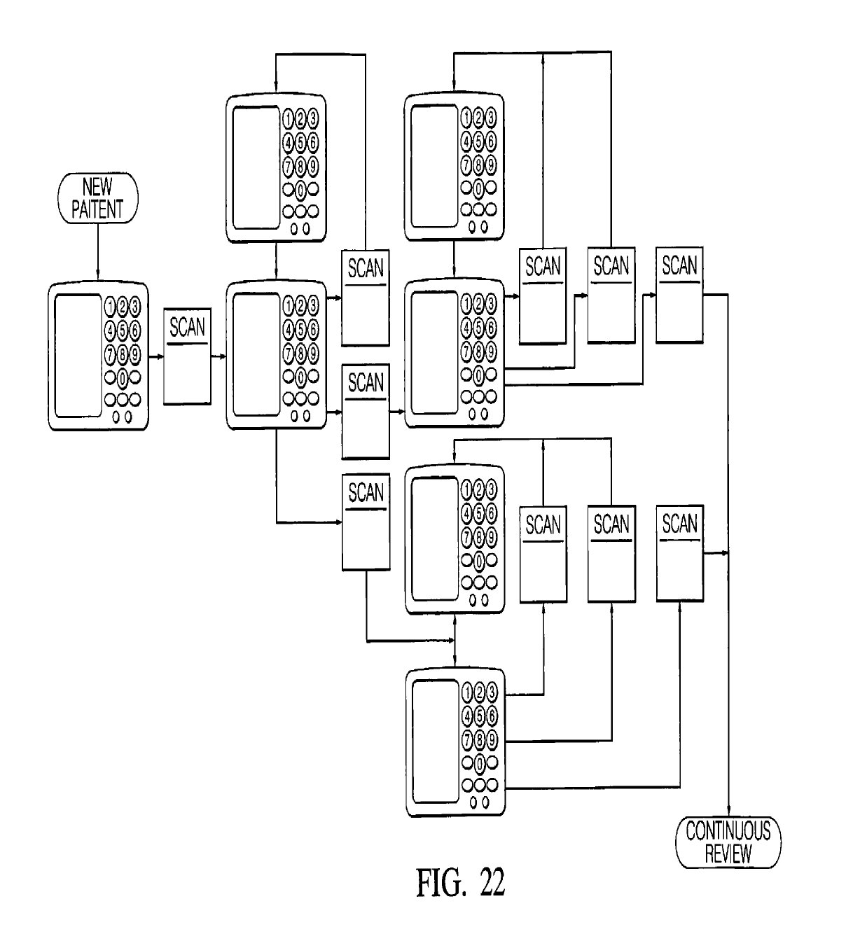

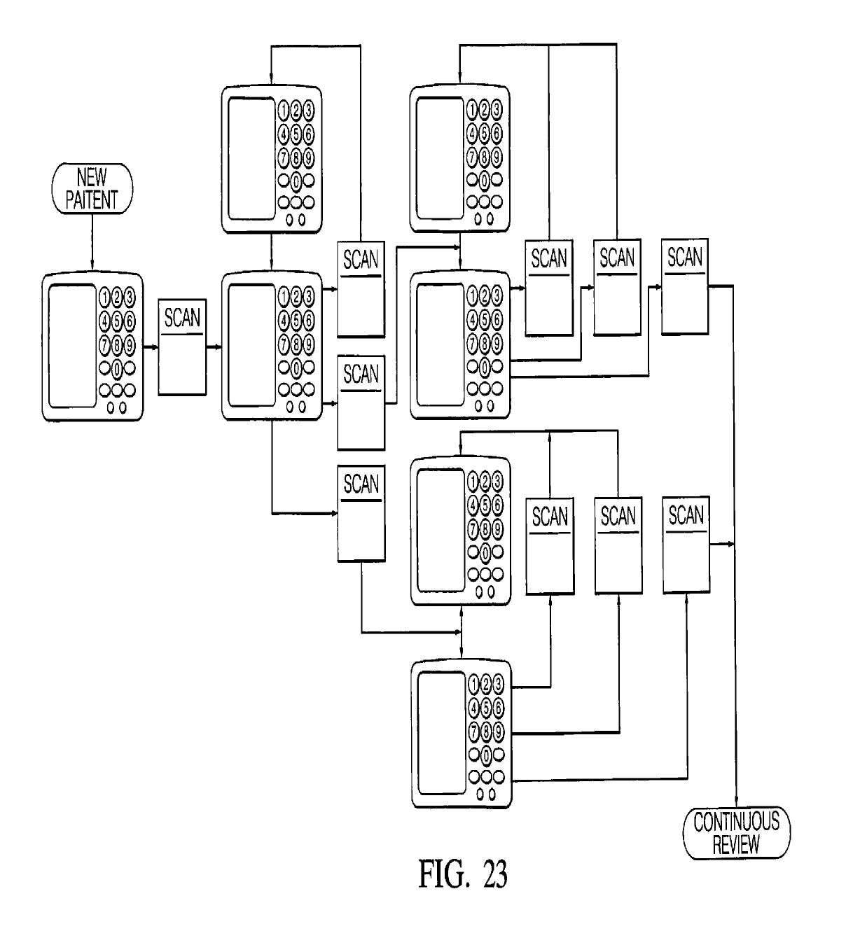

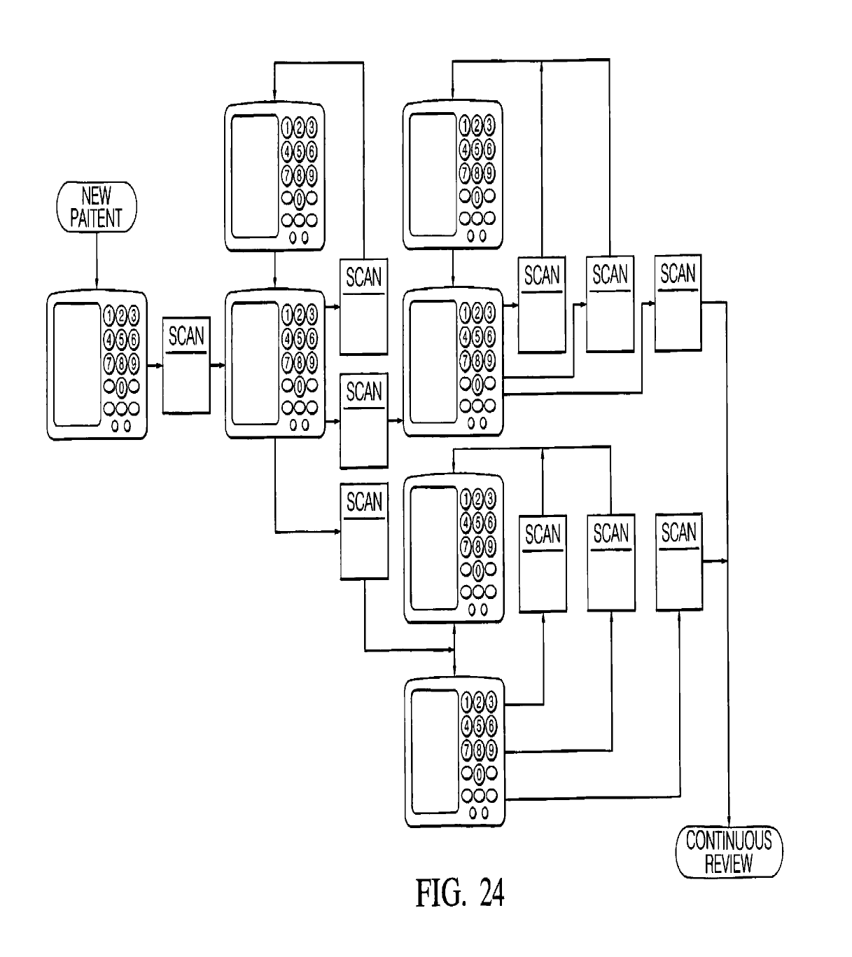

In yet another embodiment, if the user inadvertently duplicates a scan of at least one of the patient's barcode label, the drug barcode label, or the caregiver's barcode label, a screen indicating the same will appear on the display. The screen may, in an example, also prompt the user to enter or scan in another label instead. FIGS. 22-24 provide flow diagrams for possible duplicate scanning of the barcode for the caregiver, the barcode for the drug, and the barcode for the patient, respectively.

It is to be understood that the term “connect/connected” or the like is broadly defined herein to encompass a variety of divergent connection arrangements and assembly techniques. These arrangements and techniques include, but are not limited to 1) the direct connection between one component and another component with no intervening components therebetween; and 2) the connection of one component and another component with one or more components therebetween, provided that the one component being “connected to” the other component is somehow operatively connected to the other component (notwithstanding the presence of one or more additional components therebetween).

While several embodiments have been described in detail, it will be apparent to those skilled in the art that the disclosed embodiments may be modified. Therefore, the foregoing description is to be considered exemplary rather than limiting.

What is claimed is:

1. A method of inputting data into an infusion pump, the method comprising:
providing a user interface, including:
a data entry system for inputting data related to a drug, a subject, a caregiver, and a protocol for infusing the drug to the subject;
a display operatively associated with the data entry system; and
a processor operatively associated with the display and the data entry system, the processor having stored therein a program for prompting a user of the infusion pump, via a screen presented on the display, for a respective data entry; and
inputting the data into the user interface using the data entry system.

2. The method as defined in claim 1 wherein the data entry system is a twelve-digit keypad configured for manual entry of alpha-numeric characters.

3. The method as defined in claim 1 wherein the data entry system is a machine-readable scanner.

4. The method as defined in claim 3 wherein the machine-readable scanner is wirelessly connected to the infusion pump, and wherein the user interface further includes a receiver operatively connected thereto and configured to receive a wireless transmission of the data entry from the machine-readable scanner.

5. The method as defined in claim 1 wherein inputting is accomplished manually by:
selecting an infusion mode;
entering the subject's name, the drug name, and at least one infusion parameter;
reviewing the subject's name, the drug name, and the at least one infusion parameter; and
editing at least one of the subject's name, the drug name, or the at least one infusion parameter if, upon review thereof, at least one of the subject's name, the drug name, or the at least one infusion parameter is inaccurate.

6. The method as defined in claim 5 wherein the subject is a new patient, and wherein prior to selecting the infusion mode, inputting the data further includes selecting a desired care area.

7. The method as defined in claim 5 wherein the subject is a new patient, and wherein prior to selecting the infusion mode, inputting the data further includes adjusting one or more infusion pump options selected from a volume level, an air-in-line trigger, an occlusion trigger, a downstream occlusion retry, or combinations thereof.

8. The method as defined in claim 5, further comprising selecting a quick start mode.

9. The method as defined in claim 5 wherein: the infusion mode is a continuous delivery based on a weight of the subject; the at least one infusion parameter includes the subject's weight, a volume of the drug to be infused, a concentration of the drug, a dosage amount, and an infusion rate; and wherein inputting the data further includes entering the subject's weight, the volume of the drug to be infused, the dosage amount, and the infusion rate.

10. The method as defined in claim 9 wherein inputting the data further includes entering the concentration of the drug.

11. The method as defined in claim 9 wherein inputting the data further includes:
selecting to change the infusion rate; and
entering a new dose.

12. The method as defined in claim 9 wherein inputting the data further includes titrating the drug by entering a titration flow rate and a time limit for titrating.

13. The method as defined in claim 9 wherein inputting the data further includes:
selecting a secondary infusion mode;
entering a new weight for the subject, a new volume of the drug to be infused, a new dosage amount, and a new infusion rate, each of the new weight, volume, dosage amount and rate corresponding to the secondary infusion mode selected.

14. The method as defined in claim 9 wherein inputting the data further includes:
confirming that a slider for the infusion pump is not in an occluded position;
determining whether the infusion pump is primed; and
if the infusion pump is not primed, priming the infusion pump.

15. The method as defined in claim 5 wherein: the infusion mode is a continuous delivery; the at least one infusion parameter includes a volume of the drug to be infused, a concentration of the drug, a dosage amount, and an infusion rate; and inputting the data further includes entering the volume of the drug to be infused, the dosage amount, and the infusion rate.

16. The method as defined in claim 15 wherein inputting the data further includes entering the concentration of the drug.

17. The method as defined in claim 15 wherein inputting the data includes:
selecting to change the infusion rate; and
entering a new infusion rate.

18. The method as defined in claim 15 wherein inputting the data further includes:
selecting a secondary infusion mode; and
entering a new volume of the drug to be infused, a new dosage amount, and a new infusion rate, each of the new volume, new dosage amount, and new rate corresponding to the secondary infusion mode selected.

19. The method as defined in claim 15 wherein inputting the data further includes:
confirming that a slider for the infusion pump is not in an occluded position;
determining whether the infusion pump is primed; and
if the infusion pump is not primed, priming the infusion pump.

20. The method as defined in claim 5 wherein: the infusion mode is a multi-step intermittent delivery; the at least one infusion parameter includes a volume of a reservoir including the drug, a concentration of the drug to be infused, a dosage amount with an infusion time and an infusion rate associated therewith, and an other dosage amount with an other infusion time and an other infusion rate associated therewith; and inputting the data further includes entering the volume of the reservoir including the drug, the dosage amount with the infusion time and the infusion rate associated therewith, and the other dosage amount with the other infusion time and the other infusion rate associated therewith.

21. The method as defined in claim 20 wherein inputting the data further includes entering the concentration of the drug.

22. The method as defined in claim 20 wherein inputting the data further includes:
confirming that a slider for the infusion pump is not in an occluded position;
determining whether the infusion pump is primed; and
if the infusion pump is not primed, priming the infusion pump.

23. The method as defined in claim 20 wherein inputting the data further includes:
determining whether the reservoir is empty; and
when the reservoir is empty, changing the reservoir by:
entering a new reservoir volume;
confirming that a slider of the infusion pump is not in an occluded position;
determining whether the infusion pump is primed; and
if the infusion pump is not primed, priming the infusion pump.

24. The method as defined in claim 5 wherein: the infusion mode is a dosage-based intermittent delivery; the at least one infusion parameter includes a number of doses, a dosage amount, a duration of each dose, a delay time between each dose, a concentration of the drug to be infused, and a keep vein open (KVO) rate; and inputting the data further includes entering, into respective screens on the display, the number of doses, the dosage amount, the duration of each dose, the delay time between each dose, and the KVO rate.

25. The method as defined in claim 24 wherein inputting the data further includes entering the concentration of the drug.

26. The method as defined in claim 24 wherein inputting the data further includes:
confirming that a slider for the infusion pump is not in an occluded position;
determining whether the infusion pump is primed; and
when the infusion pump is not primed, priming the infusion pump.

27. The method as defined in claim 24 wherein inputting the data further includes:
determining if a reservoir containing the drug is empty; and
when the reservoir is empty, changing the reservoir by:
entering a new reservoir volume;
confirming that a slider of the infusion pump is not in an occluded position;
determining whether the infusion pump is primed; and
if the infusion pump is not primed, priming the infusion pump.

28. The method as defined in claim 5 wherein: the infusion mode is a patient-controlled analgesia delivery; the at least one infusion parameter includes a volume of a reservoir containing the drug, a concentration of the drug to be infused, a basal flow rate, a bolus dose, and a loading dose; and inputting the data further includes:
entering the reservoir volume and the basal flow rate; and
determining whether at least one of the bolus dose and the loading dose will be used.

29. The method as defined in claim 28 wherein when the bolus dose is used, inputting the data further includes:
entering the bolus dose and a lock-out time;
determining whether the number of doses are limited based on time; and
when the number of doses are limited based on time, entering a maximum number of doses per time.

30. The method as defined in claim 28 wherein when the loading dose is used, inputting the data further includes entering the loading dose.

31. The method as defined in claim 28 wherein inputting the data further includes:
confirming that a slider for the infusion pump is not in an occluded position;
determining whether the infusion pump is primed; and
if the infusion pump is not primed, priming the infusion pump.

32. The method as defined in claim 28 wherein inputting the data further includes changing the basal flow rate by:
entering a new basal flow rate;
determining whether a new dose is needed; and
when a new dose is needed, entering the new dose and a new lock-out time.

33. The method as defined in claim 32 wherein inputting the data further includes:
determining whether the new dose is limited based on time; and
when the new dose is limited based on time, entering a new maximum dose per time.

34. The method as defined in claim 28 wherein inputting the data further includes:
determining whether the reservoir is empty; and
when the reservoir is empty, changing the reservoir by:
entering a new reservoir volume;
confirming that a slider of the infusion pump is not in an occluded position;
determining whether the infusion pump is primed; and
when the infusion pump is not primed, priming the infusion pump.

35. The method as defined in claim 5 wherein: the infusion mode is a total parenteral nutrition (TPN) delivery; the at least one infusion parameter includes a volume of the drug to be infused, a concentration of the drug to be infused, a ramp down time, a total infusion time, a dose; and inputting the data further includes:
entering the volume of the drug to be infused and the ramp down time; and
selecting the infusion mode to be accomplished by one of a rate of infusing the drug or by a time for infusing the drug.

36. The method as defined in claim 35 wherein when the infusion mode is accomplished by the rate of infusing the drug, inputting the data further includes entering the concentration of the drug and the dose.

37. The method as defined in claim 35 wherein when the infusion mode is accomplished by the time of infusing the drug, inputting the data further includes entering a total time for infusing the drug.

38. The method as defined in claim 35 wherein inputting the data further includes ramping down a flow rate of the drug by entering the ramp down time.

39. The method as defined in claim 1 wherein the entry system is a machine-readable scanner, and wherein inputting is accomplished by:
scanning, via the machine-readable scanner, a machine-readable label for the subject, the machine-readable label including data related to the subject; and
scanning a machine-readable label for a container containing the drug, the machine-readable label for the container including data related to the drug and to the protocol for infusing the drug.

40. The method as defined in claim 5 wherein the infusion mode is identified with a color presented on the screen of the display.

41. The method as defined in claim 1, further comprising locking at least one of the screens on the display by:
selecting a screen-lock option; and
entering a screen-lock password.

42. The method as defined in claim 1 wherein inputting the data further includes:
selecting a delayed infusion option;
selecting to edit a delay time according to an infusion start time;
entering the infusion start time and a current time into respective screens of the display; and
confirming at least one of the infusion parameters.

43. The method as defined in claim 1 wherein inputting the data further includes:
selecting a multi-day infusion option; and
entering a number of days for infusion.

44. The method as defined in claim 43 wherein inputting the data further includes:
selecting to delay infusing the drug;
selecting to edit the delay time by a start time of infusion; and
entering the start time of infusion and a current time.

45. The method as defined in claim 43 wherein inputting the data further includes:
selecting to delay infusing the drug;
selecting to edit a delay time by a duration of the infusion; and
entering the delay time for infusing the drug.

46. The method as defined in claim 5 wherein the infusion mode is an epidural mode, and wherein inputting the data includes selecting one of a continuous delivery, a patient-controlled analgesia (PCA) delivery, or an intermittent delivery.
